(19) United States
(12) Patent Application Publication
(10) Pub. No.: US 2025/0199390 A1
(43) Pub. Date: Jun. 19, 2025

(54) PROJECTION DEVICE AND PROJECTION SYSTEM

(71) Applicant: HISENSE LASER DISPLAY CO., LTD, Qingdao (CN)

(72) Inventors: Wei LI, Qingdao (CN); Ke YAN, Qingdao (CN); Youliang TIAN, Qingdao (CN); Xiaoqiang GU, Qingdao (CN)

(73) Assignee: HISENSE LASER DISPLAY CO., LTD, Qingdao (CN)

(21) Appl. No.: 19/064,716

(22) Filed: Feb. 27, 2025

Related U.S. Application Data
(63) Continuation of application No. PCT/CN2023/115867, filed on Aug. 30, 2023.

(30) Foreign Application Priority Data
Aug. 31, 2022 (CN) 202211055744.4
Sep. 30, 2022 (CN) 202211208529.3
Sep. 30, 2022 (CN) 202211216165.3

(51) Int. Cl. G03B 21/20; G03B 21/00

(52) U.S. Cl. CPC G03B 21/208; G03B 21/008; G03B 21/2013; G03B 21/2033

(57) ABSTRACT

A projection device and a projection system are provided. The projection device includes a light source, an optical modulating assembly, and a lens. The light source includes a laser and a beam reshaping member. The laser is configured to emit laser light of a plurality of colors. The beam reshaping member includes a plurality of beam reshaping regions, each beam reshaping region comprises a plurality of diffraction microstructures, and the diffraction microstructures in different beam reshaping regions are different. The beam reshaping member is configured to diffract the laser light respectively and transmit the laser light toward a same region, so that light spots formed by the laser light after passing through the beam reshaping member are combined.

### CROSS-REFERENCE TO RELATED APPLICATIONS

This application is a continuation of international PCT application No. PCT/CN2023/115867, filed on Aug. 30, 2023, which claims the priority benefits of Chinese Patent application No. 202211055744.4, filed on Aug. 31, 2022, Chinese Patent application no. 202211208529.3, filed on Sep. 30, 2022, and Chinese Patent application no. 202211216165.3, filed on Sep. 30, 2022. The entirety of each of the above-mentioned patent applications is hereby incorporated by reference and made a part of this application.

### TECHNICAL FIELD

The present disclosure relates to the field of laser projection technology, and in particular, to a projection device and a projection system.

### BACKGROUND

With the development of laser projection technology, projection devices have gradually entered people's lives and become a common item in people's work and life. A light source in the projection device can emit lasers of various colors, based on which a projection image can be formed. Moreover, the higher the symmetry of the lasers of various colors emitted from the light source, the better the mixing effect, and the better the display effect of the projection image.

### SUMMARY

In one aspect, a projection device is provided. A projection device includes a light source, a light homogenizing member, an optical modulating assembly, and a lens. The light source is configured to emit laser light of a plurality of colors as an illumination beam. The light homogenizing member is located on a light outgoing side of the light source and is configured to homogenize the illumination beam incident thereon. The optical modulating assembly is configured to modulate the homogenized illumination beam to obtain a projection beam. The lens is located on a light outgoing side of the optical modulating assembly and is configured to project the projection beam to form a projection image. The light source includes at least one laser and a beam reshaping member. The laser is configured to emit the laser light of the plurality of colors. The beam reshaping member includes a plurality of beam reshaping regions, the laser light of the plurality of colors is respectively incident on the plurality of beam reshaping regions, and the laser light of different colors is respectively incident on different beam reshaping regions, a size of each of a plurality of light spots formed by the laser light of the plurality of colors on the beam reshaping member in a first direction is greater than a size of the same light spot in a second direction, the first direction being perpendicular to the second direction, each of the beam reshaping regions includes a plurality of diffraction microstructures, the diffraction microstructures in different beam reshaping regions are different, the beam reshaping member are configured to diffract the laser light of the plurality of colors through the plurality of diffraction microstructures in the plurality of beam reshaping regions respectively to form a plurality of rectangular spots and transmit the laser light of the plurality of colors toward a same region, so that a plurality of light spots formed by the laser light of the plurality of colors after passing through the beam reshaping member are combined, wherein a size and a shape of each rectangular spot match a size and a shape of a light spot required by the light homogenizing member.

In another aspect, a projection system is provided. The projection system includes the above-mentioned projection device and a projection screen located on a light outgoing side of the projection device.

### BRIEF DESCRIPTION OF THE DRAWINGS

In order to describe the technical solution in the present disclosure more clearly, the following briefly describes the accompanying drawings required for some embodiments of the present disclosure. However, the accompanying drawings in the following description are merely the drawings of some embodiments of the present disclosure. For those skilled in the art, other drawings may be obtained according to these drawings. In addition, the drawings in the following description may be regarded as schematic diagrams, and are not limited to the actual size of the product, the actual process of the method, the actual timing of the signal, etc., of the embodiments of the present disclosure.

FIG. 1 is a schematic structural view of a projection system according to some embodiments.

FIG. 2 is a perspective view of a projection device according to some embodiments.

FIG. 3 is a diagram of a light path between a light source, an optical modulating assembly, and a lens in a projection device according to some embodiments.

FIG. 4 is a diagram of a light path between a light source and a light guide according to some embodiments.

FIG. 5 is a schematic structural view of a light source according to some embodiments.

FIG. 6 is a schematic structural view of a laser according to some embodiments.

FIG. 7 is a schematic view of light spots formed on a beam reshaping member by laser light emitted from the laser of FIG. 6.

FIG. 8 is a schematic structural view of a laser according to other embodiments.

FIG. 9 is a schematic view of light spots formed on a beam reshaping member by laser light emitted from the laser of FIG. 8.

FIG. 10 is a schematic structural view of a light source according to other embodiments.

FIG. 11 is a schematic structural view of a beam reshaping member of the light source of FIG. 10.

FIG. 12 is an energy distribution diagram of laser light according to some embodiments.

FIG. 13 is an energy distribution diagram of laser light according to other embodiments.

FIG. 14 is an energy distribution diagram of laser light according to yet other embodiments.

FIG. 15 is a schematic structural view of a light source according to yet other embodiments.

FIG. 16 is a partial schematic structural view of a beam reshaping member of the light source of FIG. 15.

FIG. 17 is a schematic structural view of a light source according to yet other embodiments.

FIG. 18 is a perspective view of a projection device according to other embodiments.

FIG. 19 is a schematic structural view of a laser according to yet other embodiments.

FIG. 20 is a schematic structural view of a light source according to yet other embodiments.

FIG. 21 is a diffraction diagram of a volume grating according to some embodiments.

FIG. 22 is a schematic structural view of a volume grating and a light valve according to some embodiments.

FIG. 23 is a perspective view of an optical modulating assembly in a projection device according to some embodiments.

FIG. 24 is a perspective view of an optical modulating assembly in a projection device according to other embodiments.

FIG. 25 is a schematic structural view of a projection device according to yet other embodiments.

FIG. 26 is a schematic structural view of an array optical waveguide according to some embodiments.

FIG. 27 is a schematic structural view of a sawtooth-shaped optical waveguide according to some embodiments.

FIG. 28 is a light path diagram of a light source according to yet other embodiments.

FIG. 29 is a light path diagram of a light source according to yet other embodiments.

FIG. 30 is a schematic structural view of a projection device according to yet other embodiments.

FIG. 31 is a light path diagram of a light source according to yet other embodiments.

FIG. 32 is a light path diagram of a light source according to yet other embodiments.

FIG. 33 is a light path diagram of a light source according to yet other embodiments.

### DETAILED DESCRIPTION OF THE EMBODIMENTS

In order to make the above objects, features and advantages of the present disclosure clear and easier to understand, the specific embodiments of the present disclosure are described in detail below in combination with the accompanying drawings. Many specific details are set forth in the following description to facilitate a full understanding of the present disclosure. However, the present disclosure can be implemented in many ways different from those described herein, and those skilled in the art can make similar improvements without departing from the connotation of the present disclosure. Therefore, the present disclosure is not limited by the specific embodiments disclosed below.

Unless the context otherwise requires, in the entire specification and claims, the term “include” and its other forms such as the third person singular form “includes” and the present participle form “including” are construed as open and inclusive, that is, “includes, but is not limited to”. In the specification, the terms “one embodiment”, “some embodiments”, “exemplary embodiment”, “example”, “specific example” or “some examples” and the like are intended to indicate that specific features, structures, materials, or characteristics related to this embodiment or example are included in at least one embodiment or example of the present disclosure. The illustrative expression of the above terms does not necessarily refer to the same embodiment or example. Furthermore, the specific features, structures, materials or characteristics described herein may be combined in a suitable manner in any one or more embodiments or examples.

Hereinafter, the terms “first” and “second” are only intended for illustrative purposes, rather than being construed as indicating or implying relative importance or implicitly designating the number of the technical features as indicated. Thus, a feature defined by “first” or “second” may explicitly or implicitly include one or more said features. In the illustrations of the present disclosure, the term “a plurality of” means two or more, unless otherwise specifically defined.

When describing some embodiments, expressions such as “connection” and its derivatives may be used. The term “connection” shall be construed broadly, for example, “connection” may be a fixed connection, a detachable connection, or an integral connection. It can be a direct connection or an indirect connection through an intermediate medium. The embodiments disclosed herein are not necessarily limited to the content herein.

“At least one of A, B, and C” has the same meaning as “at least one of A, B, or C” and includes the following combinations of A, B, and C: only A, only B, only C, a combination of A and B, a combination of A and C, a combination of B and C, and a combination of A, B, and C.

“A and/or B” includes the following three combinations: only A, only B, and a combination of A and B.

The use of “adapted to” or “configured to” herein implies an open and inclusive language, which does not exclude devices that are adapted or configured to perform additional tasks or steps.

As used herein, “about”, “around” or “approximate” includes the values set forth and an average value within an acceptable deviation range of a particular value, wherein the acceptable deviation range is as determined by one of ordinary skill in the art, taking into account the measurement under discussion and errors associated with a particular amount of measurement, i.e., limitations of the measurement system.

Generally, in a projection device using a laser as a light source, since the arrangement positions of light emitting chips in the laser are different, the positions of light spots of different colors of laser light emitted from the laser are different. Moreover, due to the requirements of color matching and laser power, the number of light emitting chips that emit red laser light is generally higher than the number of light emitting chips that emit blue laser light or green laser light. Therefore, beam widths of the blue laser light and the green laser light are different from a beam width of the red laser light. In this way, after laser light of different colors is combined, the uniformity of the light spots of the combined laser light is poor, which affects the display effect of the projection image.

In order to solve the above problem, a projection system is provided according to some embodiments.

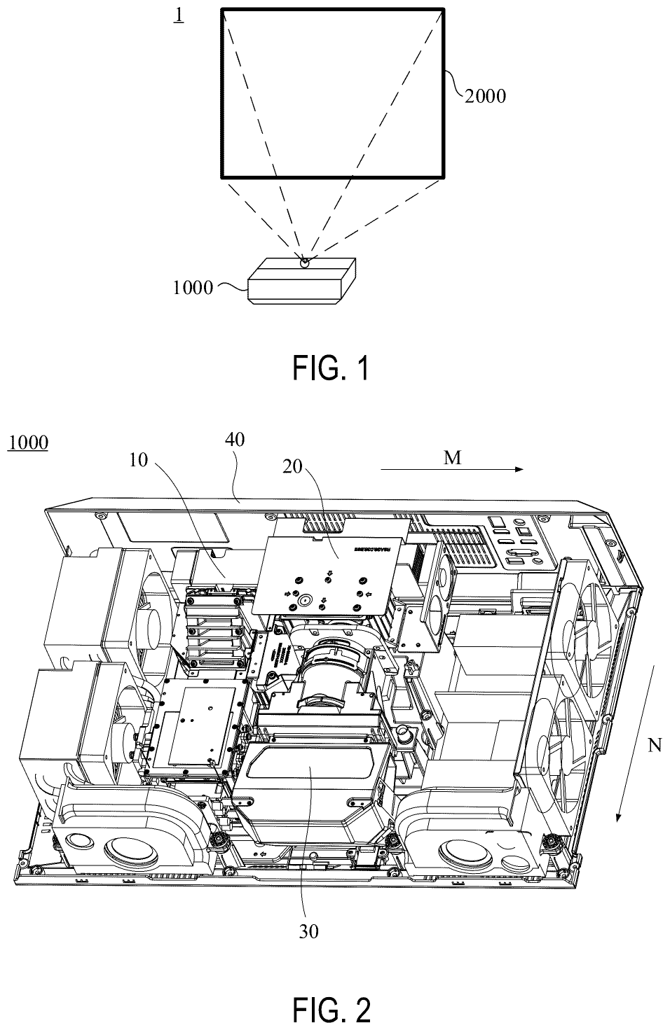

FIG. 1 is a schematic structural view of a projection system according to some embodiments. As shown in FIG. 1, the projection system 1 includes a projection device 1000 and a projection screen 2000. The projection screen 2000 is located on a light outgoing side of the projection device 1000, and the projection screen 2000 is configured to face viewers. A projection beam emitted from the projection device 1000 is incident on the projection screen 2000, and is reflected by the projection screen 2000 to enter the human eyes, so that the viewer can view the projection image.

FIG. 2 is a perspective view of a projection device according to some embodiments.

As shown in FIG. 2, the projection device 1000 includes a housing 40 (only a part of the housing 40 is shown in FIG. 2), a light source 10 mounted in the housing 40, an optical modulating assembly 20, and a lens 30. The light source 10 is configured to provide an illumination beam (e.g., laser light). The optical modulating assembly 20 is configured to modulate the illumination beam provided by the light source 10 with an image signal to obtain a projection beam. The image signal may come from a control unit communicatively connected to the projection device 1000, and the control unit generates the image signal according to an image to be projected and transmits the image signal to the projection device 1000. The lens 30 is configured to project the projection beam onto the projection screen 2000 or a wall to form a projection image.

The light source 10, the optical modulating assembly 20, and the lens 30 are sequentially connected along a propagation direction of the light beam, and are each enclosed by portions of the housing 40. The portions of the housing 40 respectively corresponding to the light source 10, the optical modulating assembly 20, and the lens 30 support corresponding optical components and enable the optical components to meet certain sealing or airtight requirements.

One end of the optical modulating assembly 20 is connected to the light source 10, and the light source 10 and the optical modulating assembly 20 are provided along an outgoing direction (refer to a direction M in FIG. 2) of the illumination beam of the projection device 1000. The other end of the optical modulating assembly 20 is connected to the lens 30, and the optical modulating assembly 20 and the lens 30 are provided along an outgoing direction (refer to a direction Nin FIG. 2) of the projection beam of the projection device 1000. The outgoing direction M of the illumination beam is substantially perpendicular to the outgoing direction N of the projection beam. Such a connection structure can adapt to the light path characteristics of a reflective light valve in the optical modulating assembly 20. Meanwhile, it is also beneficial to shortening a length of the light path in one dimensional direction, which is beneficial to the structural arrangement of the whole device. For example, when the light source 10, the optical modulating assembly 20, and the lens 30 are provided in one dimensional direction (e.g., the direction M), the length of the light path in the dimensional direction will be very long, which is not conducive to the structural arrangement of the whole device. The reflective light valve will be described later.

In some embodiments, the light source 10 may provide three primary colors of light in a time-sequential manner, and may also provide other colors of light on the basis of the three primary colors of light. Due to the persistence of vision of the human eyes, the human eyes see white light formed by the mixture of the three primary colors of light. Alternatively, the light source 10 may simultaneously emit three primary colors of light and continuously emit white light. The light source 10 may include a laser that may emit laser light of at least one color, such as red laser light, blue laser light, or green laser light. In the case where the laser emits the laser light of one color, the laser may be referred to as a monochromatic laser. In this case, the light source 10 may further include a fluorescent wheel, and the monochromatic laser cooperates with the fluorescent wheel to cause the light source to emit light beams of a plurality of colors.

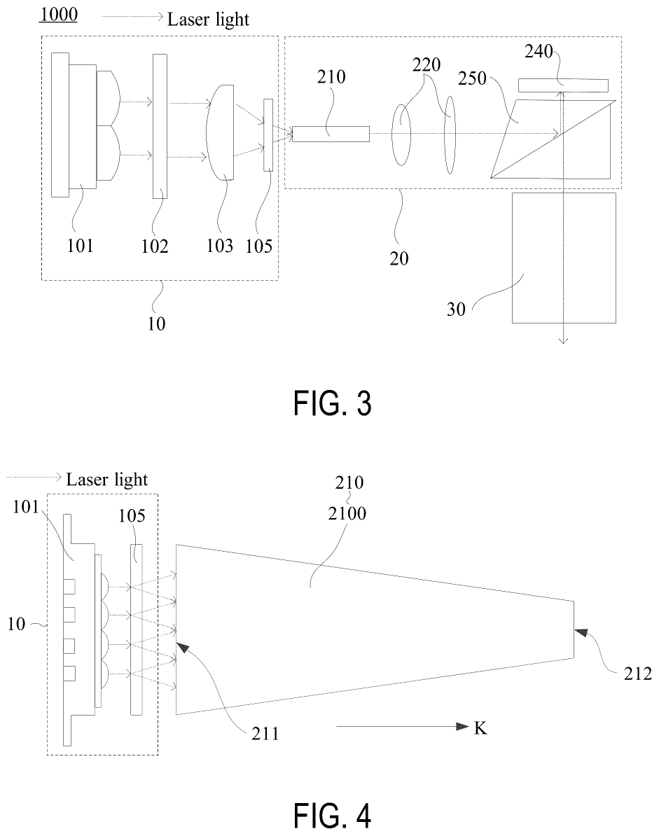

FIG. 3 is a diagram of a light path between a light source, an optical modulating assembly, and a lens in a projection device according to some embodiments. As shown in FIG. 3, the optical modulating assembly 20 includes a light homogenizing member 210, a lens assembly 220, a light valve 240 (i.e., an optical modulating member), and a prism assembly 250. The light homogenizing member 210 is configured to homogenize the illumination beam incident thereon and transmit the illumination beam to the lens assembly 220. The lens assembly 220 may first collimate the illumination beam and then converge the illumination beam and transmit the illumination beam to the prism assembly 250. The prism assembly 250 reflects the illumination beam to the light valve 240. The light valve 240 is configured to modulate the illumination beam incident thereon into the projection beam according to the image signal, and to direct the projection beam toward the lens 30.

In some embodiments, a light incident surface of the light homogenizing member 210 is rectangular. For example, the light homogenizing member 210 includes a light guide having a rectangular light inlet. The illumination beam from the light source 10 is incident into the light guide and is reflected in the light guide for transmission at random angles, thereby improving the uniformity of the illumination beam transmitted from the light guide.

In some embodiments, the light homogenizing member 210 includes a fly-eye lens assembly composed of two fly-eye lenses opposite to each other, and the fly-eye lens is formed by a plurality of microlenses in an array. Along the incident direction of the illumination beam, a focal point of the microlens in a first fly-eye lens coincides with a center of the corresponding microlens in a second fly-eye lens, and optical axes of the microlenses in the two fly-eye lenses are parallel to each other. By the fly-eye lens assembly, the light spot of the illumination beam can be divided. In addition, the divided spots can be accumulated by the lens assembly 220. In this way, the illumination beam can be homogenized.

It should be noted that the light homogenizing member 210 may alternatively be provided in the light source 10. For example, the light source 10 includes the light homogenizing member 210, and in this case, the light homogenizing member 210 may not be provided in the optical modulating assembly 20.

FIG. 4 is a diagram of a light path between a light source and a light guide according to some embodiments, and a side view of the light guide is included in FIG. 4. In some embodiments, as shown in FIG. 4, the light homogenizing member 210 includes a wedge-shaped light guide 2100. An area of a cross section of the light guide 2100 decreases along a transmission direction of the illumination beam (e.g., a direction K in FIG. 4). For example, as shown in FIG. 4, the light guide 2100 includes a first end 211 and a second end 212. The first end 211 is adjacent to the light source 10 and is an incident end to receive the illumination beam from the light source 10. The second end 212 is away from the light source 10 and is an outgoing end, and the illumination beam homogenized by the light guide 2100 is transmitted out of the light guide 2100 from the second end 212. An area of a cross section of the first end 211 is greater than an area of a cross section of the second end 212. Herein, the cross section of the light guide 2100 may refer to a cross section of the light guide 2100 on a plane (target plane) perpendicular to the transmission direction of the illumination beam.

The wedge-shaped light guide 2100 can directly receive the illumination beam of the light source 10, and the illumination beam may not need to be converged by a converging lens or other structures, which is conducive to simplifying the structure of the projection device 1000 and facilitating the miniaturization of the projection device 1000.

The lens assembly 220 may include a convex lens, such as a plano-convex lens, a biconvex lens, or a concave-convex lens (also known as a positive meniscus lens). The convex lens may be a spherical lens or an aspherical lens.

The prism assembly 250 may be a total internal reflection (TIR) prism assembly or a total refraction total Internal reflection (RTIR) prism assembly.

The light valve 240 may be a reflective light valve. The light valve 240 includes a plurality of reflection sheets, each of which may be configured to form a pixel in the projection image. The light valve 240 may adjust the plurality of reflection sheets according to an image to be displayed, so that the reflection sheet corresponding to the pixel to be displayed in a bright state in the image reflects the light beam to the lens 30, and the light beam reflected to the lens 30 is referred to as the projection beam. In this way, the light valve 240 can modulate the illumination beam to obtain the projection beam, and the projection image is displayed through the projection beam.

In some embodiments, the light valve 240 may be a digital micromirror device (DMD).

The digital micromirror device includes a plurality (e.g., thousands) of tiny reflection mirrors that can be individually driven to rotate. The tiny reflection mirrors may be arranged in an array. One tiny reflection mirror (e.g., each tiny reflection mirror) corresponds to one pixel in the projection image to be displayed. After processing, the image signal can be converted into digital codes such as 0 and 1. In response to the digital codes, the tiny reflection mirror can oscillate. A gray scale of each pixel in a frame of image is achieved by controlling a duration of each tiny reflection mirror in an on state and an off state. In this way, the digital micromirror device can modulate the illumination beam to display the projection image.

The lens 30 includes a plurality of lens groups, which are generally divided into three groups, i.e., a front group, a middle group, and a rear group, or two groups, i.e., a front group and a rear group. The front group is a lens group adjacent to the light outgoing side of the projection device 1000, that is, a lens group away from the light outgoing side of the optical modulating assembly 20. The rear group is a lens group adjacent to the light outgoing side of the optical modulating assembly 20. The lens 30 may be a zoom lens, or a prime adjustable lens, or a prime lens. In some embodiments, the projection device 1000 may be an ultra-short throw projection device, and the lens 30 may be an ultra-short throw projection lens.

For the convenience of description, some embodiments of the present disclosure are mainly described by taking the projection device 1000 adopting a digital light processing (DLP) projection architecture and the light valve 240 being a digital micromirror device as an example, which does not limit the present disclosure.

The light source 10 in some embodiments of the present disclosure is described in detail below.

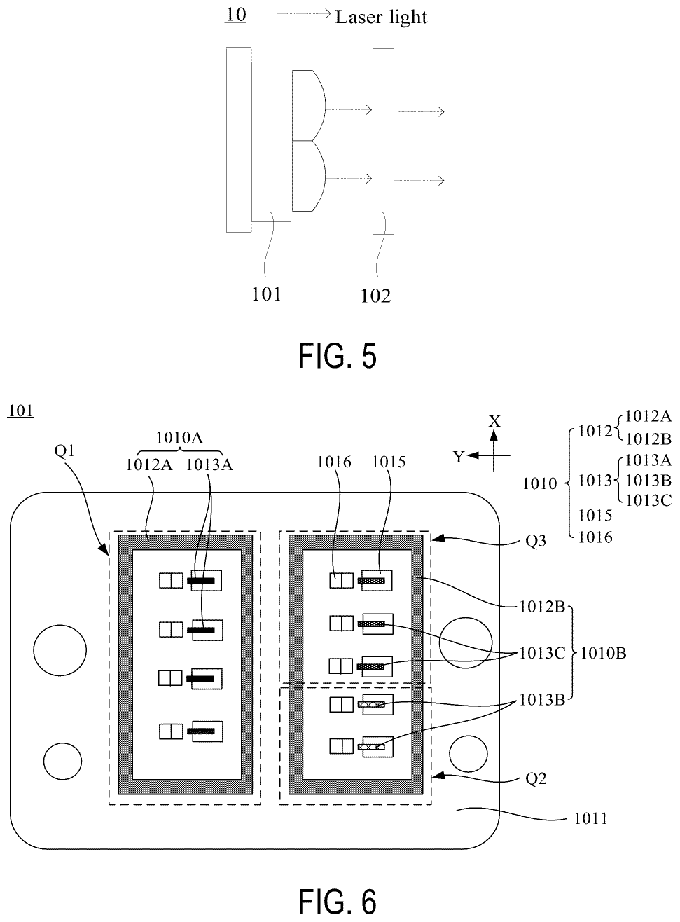

FIG. 5 is a schematic structural view of a light source according to some embodiments. In some embodiments, as shown in FIG. 5, the light source 10 includes a laser 101 and a beam reshaping member 102.

The laser 101 is configured to emit laser light of a plurality of colors, and the beam reshaping member 102 includes a plurality of beam reshaping regions. The laser light of different colors may be directed to different beam reshaping regions in the beam reshaping member 102, and the laser light of the plurality of colors may correspond to the plurality of beam reshaping regions in the beam reshaping member 102, respectively. The laser light of each color is directed to the corresponding beam reshaping region, and the beam reshaping region is configured to adjust the laser light of the corresponding color. The plurality of beam reshaping regions may each include a plurality of diffraction microstructures, and the diffraction microstructures in different beam reshaping regions are different. For example, shapes of the diffraction microstructures in different beam reshaping regions are different. Alternatively, positions of the diffraction microstructures in different beam reshaping regions are different. Alternatively, shapes of the diffraction microstructures in different beam reshaping regions are different, and positions of the diffraction microstructures in different beam reshaping regions are different. The beam reshaping member 102 is configured to diffract the received laser light of a plurality of colors through the plurality of diffraction microstructures in the plurality of beam reshaping regions, respectively and transmit the laser light toward the same region, so that light spots formed by the laser light of the plurality of colors after passing through the plurality of beam reshaping regions can be combined.

In some embodiments, different outgoing regions of the laser 101 may emit laser light of different colors. For example, the laser 101 is a multi-chip laser diode (MCL) type laser, and the laser 101 emits red laser light, green laser light, and blue laser light. The laser light of the three colors are respectively incident on three beam reshaping regions of the beam reshaping member 102, and each beam reshaping region can diffract the laser light of the corresponding color incident thereon. The red laser light, green laser light, and blue laser light, which are emitted after passing through the beam reshaping member 102 can be directed to the same region, and three light spots formed by the three colors of laser light can be combined, thereby achieving light combination of the three colors of laser light. It should be noted that the case that the light spots can be combined includes the case that the light spots roughly coincide, and the case that some small areas in the two light spots are staggered also belongs to the scope of the coincidence of the light spots. The laser may alternatively be other types of lasers, which is not limited.

In the following, the laser 101 emits red, green and blue laser light as an example. The laser 101 may also emit other laser light having colors different from the laser light of the three colors, which is not limited.

It should be noted that by designing the structure of a diffraction member, the laser light can be diffracted by the diffraction member to achieve a required effect. For example, the outgoing direction, the light intensity, and the incident position of the laser light are adjusted by diffraction of the diffraction member. The beam reshaping member 102 is the diffraction member through which laser light of different colors can be transmitted to the same region, and the sizes of the light spots formed by the laser light of different colors can be substantially the same, thereby achieving the combination of the light spots of different colors. The specific structure of the diffraction member can be designed according to the region to which the laser light needs to be transmitted and the size and shape of the light spot to be formed.

FIG. 6 is a schematic structural view of a laser according to some embodiments. In some embodiments, as shown in FIG. 6, the laser 101 includes a bottom plate 1011 and a light emitting assembly 1010. The light emitting assembly 1010 includes a frame 1012 and a plurality of light emitting chips 1013. The frame 1012 and the plurality of light emitting chips 1013 are provided on the bottom plate 1011, and the frame 1012 surrounds the plurality of light emitting chips 1013. The plurality of light emitting chips 1013 are configured to emit laser light of a plurality of colors.

The light emitting assembly 1010 may further include a plurality of heat sinks 1015 and a plurality of reflection prisms 1016. The plurality of heat sinks 1015 and the plurality of reflection prisms 1016 respectively correspond to the plurality of light emitting chips 1013. The plurality of heat sinks 1015 are provided on the bottom plate 1011, and each light emitting chip 1013 is located on corresponding heat sink 1015. The heat sink 1015 is configured to dissipate heat for corresponding light emitting chip 1013. The reflection prism 1016 is located on a light outgoing side of the corresponding light emitting chip 1013 to reflect the laser light emitted from the light emitting chip 1013.

Moreover, the light emitting assembly 1010 may further include a light transmissive layer and a collimating lens assembly. The light transmissive layer is provided on a side of the frame 1012 away from the bottom plate 1011, and is configured to close an opening on the side of the frame 1012 away from the bottom plate 1011. The collimating lens assembly is located on a side of the light transmissive layer away from the bottom plate 1011 and is configured to collimate the laser light emitted from the light emitting chip 1013. The light emitting chip 1013 can emit laser light to the corresponding reflection prism 1016, and the reflection prism 1016 can reflect the received laser light to the collimating lens assembly in a direction away from the bottom plate 1011. Then the laser light is collimated by the collimating lens assembly and then is transmitted.

In some examples, as shown in FIG. 6, the laser 101 includes a plurality of light emitting assemblies 1010, and the plurality of light emitting assemblies 1010 include a first light emitting assembly 1010A and a second light emitting assembly 1010B. The first light emitting assembly 1010A includes a first frame 1012A and a plurality of first light emitting chips 1013A surrounded by the first frame 1012A. The second light emitting assembly 1010B includes a second frame 1012B, a plurality of second light emitting chips 1013B, and a plurality of third light emitting chips 1013C. The plurality of second light emitting chips 1013B and the plurality of third light emitting chips 1013C are surrounded by the second frame 1012B. The first light emitting chip 1013A is configured to emit red laser light, the second light emitting chip 1013B is configured to emit blue laser light, and the third light emitting chip 1013C is configured to emit green laser light. For convenience of description, the laser light emitted from each light emitting chip 1013 is referred to as a sub-beam.

It is described by taking an example that the laser 101 includes two light emitting assemblies 1010, the first light emitting assembly 1010A includes four first light emitting chips 1013A, and the second light emitting assembly 1010B includes two second light emitting chips 1013B and three third light emitting chips 1013C.

A region where the four first light emitting chips 1013A are located may be a first light outgoing region Q1 of the laser 101, a region where the two second light emitting chips 1013B are located may be a second light outgoing region Q2 of the laser 101, and a region where the three third light emitting chips 1013C are located may be a third light outgoing region Q3 of the laser 101. The laser light of each color emitted from the laser 101 may be directed to a beam reshaping region in the beam reshaping member 102, and the laser light of each color may include one or more sub-beams emitted from one or more light emitting chips 1013, respectively. Some embodiments of the present disclosure are described by taking the example that the laser light of each color in the laser 101 corresponds to two or more light emitting chips 1013, and the laser light of each color emitted from the laser 101 includes two or more sub-beams.

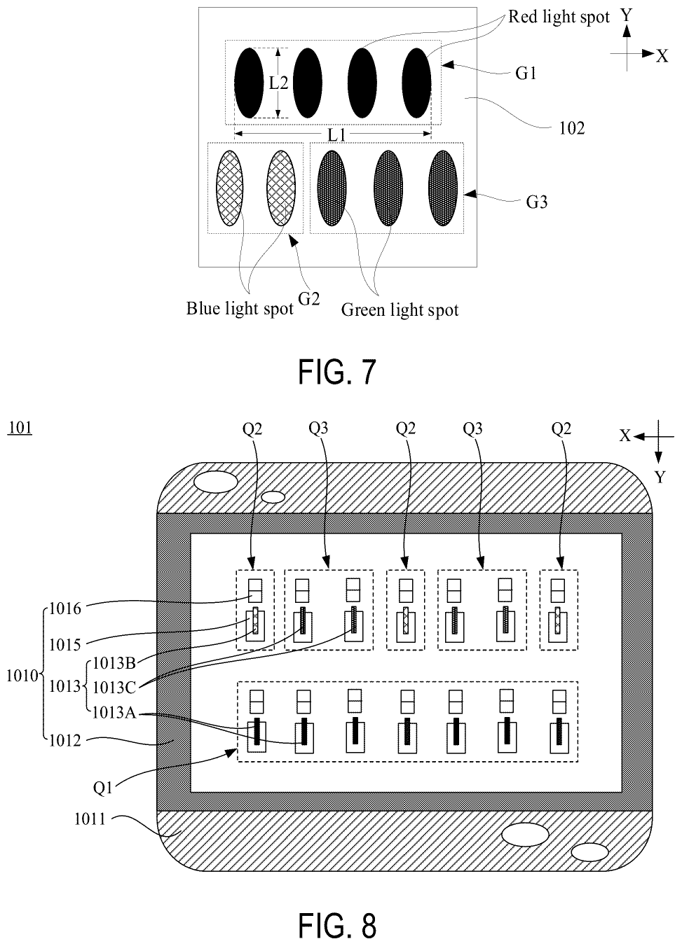

FIG. 7 is a schematic view of light spots formed on a beam reshaping member by laser light emitted from the laser of FIG. 6. As shown in FIG. 7, the laser light emitted from three light outgoing regions of the laser 101 is directed to three beam reshaping regions of the beam reshaping member 102 (a first beam reshaping region G1, a second beam reshaping region G2, and a third beam reshaping region G3), respectively. The distribution of the plurality of beam reshaping regions may be the same as the distribution of the plurality of light outgoing regions of the laser 101. The first light outgoing region Q1 of the laser 101 emits four red sub-beams to the first beam reshaping region G1 of the beam reshaping member 102, and the four red sub-beams can form four small red spots in the first beam reshaping region G1. The second light outgoing region Q2 of the laser 101 emits two blue sub-beams to the second beam reshaping region G2 of the beam reshaping member 102, and the two blue sub-beams can form two small blue light spots in the second beam reshaping region G2. The third light outgoing region Q3 of the laser 101 emits three green sub-beams to the third beam reshaping region G3 of the beam reshaping member 102, and the three green sub-beams can form three small green spots in the third beam reshaping region G3.

FIG. 8 is a schematic structural view of a laser according to other embodiments. In other embodiments, as shown in FIG. 8, the laser 101 is provided with only one frame 1012, and the plurality of light emitting chips 1013 in the laser 101 may be arranged in multiple rows and multiple columns in the frame 1012. Moreover, the second light outgoing region Q2 where the second light emitting chip 1013B is located and the third light outgoing region Q3 where the third light emitting chip 1013C is located may be at least partially overlapped. For example, as shown in FIG. 8, the laser 101 includes a light emitting assembly 1010 including one frame 1012, seven first light emitting chips 1013A, three second light emitting chips 1013B, and four third light emitting chips 1013C. The seven first light emitting chips 1013A are arranged in one row along a first direction X, and the three second light emitting chips 1013B and the four third light emitting chips 1013C are staggered in another row along the first direction X.

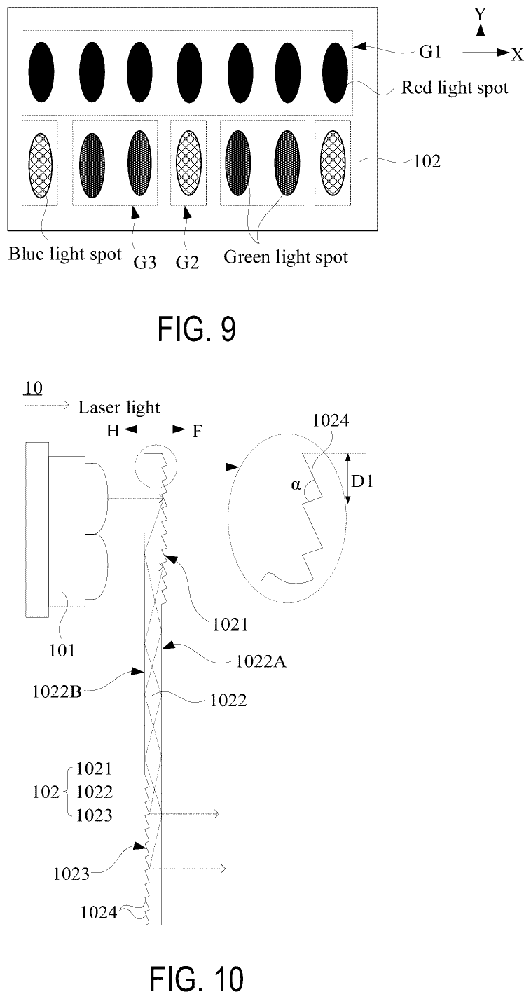

FIG. 9 is a schematic view of light spots formed on a beam reshaping member by laser light emitted from the laser of FIG. 8. A relationship between the light outgoing region of the laser 101, the beam reshaping region of the beam reshaping member 102, and the corresponding sub-beams can be referred to the relevant descriptions of FIG. 6 and FIG. 7, and are not described herein again.

In some embodiments, for any beam reshaping region in the beam reshaping member 102, the adjustment of the received laser light at different positions in the beam reshaping region may be the same, and the diffraction microstructures at different positions in the beam reshaping region may be the same. Each beam reshaping region can take the received laser light of the corresponding color as a whole to perform the same adjustment, and it is only necessary to adjust the received laser light differently in different beam reshaping regions.

For example, in the beam reshaping member 102 corresponding to FIG. 7, the first beam reshaping region G1 adjusts the received four red sub-beams in the same manner, the second beam reshaping region G2 adjusts the received two blue sub-beams in the same manner, and the third beam reshaping region G3 adjusts the received three green sub-beams in the same manner. However, the adjustment of the red sub-beam by the first beam reshaping region G1 is different from the adjustment of the blue sub-beam by the second beam reshaping region G2 and is also different from the adjustment of the green sub-beam by the third beam reshaping region G3, and the adjustment of the blue sub-beam by the second beam reshaping region G2 is different from the adjustment of the green sub-beam by the third beam reshaping region G3. In this way, the shapes, sizes, and positions of the light spots of the red laser light, the green laser light, and the blue laser light can be adjusted to be the same after being diffracted by the three beam reshaping regions. Herein, the adjustment may be understood as the adjustment of the outgoing angle, the outgoing position, and the energy of the light beam, and is not limited thereto.

In some embodiments, a region to which each sub-beam is directed in the beam reshaping region may be a sub-beam reshaping region corresponding to the sub-beam, and diffraction microstructures in different sub-beam reshaping regions may be different. Each sub-beam reshaping region may diffract the received sub-beam with the diffraction microstructure therein to expand the sub-beam. After being diffracted through the corresponding sub-beam reshaping regions, the sub-beams directed to the beam reshaping member 102 can be expanded, so that the sizes of the light spots formed by the plurality of sub-beams are increased, and the shapes and sizes of the light spots and the positions at which the corresponding sub-beams are directed can be the same, so that the light spots formed by the plurality of sub-beams can coincide.

Continuing to refer to FIG. 7 and FIG. 9, a size of the light spot formed on the beam reshaping member 102 by the laser light of the corresponding color emitted from the laser 101 in the first direction X is greater than a size of the same light spot in a second direction Y, and the light spot is formed by a plurality of small light spots of the sub-beams of the same color. For example, in FIG. 7, a size L1 of the light spot formed by four small red light spots in the first direction X is greater than a size L2 of the light spot in the second direction Y. The first direction X may be perpendicular to the second direction Y. Herein, the size of the light spot in any direction refers to a distance between two farthest points in the light spot in that direction. As shown in FIG. 7 and FIG. 9, before being diffracted by the beam reshaping member 102, the light spots formed by the laser light of the plurality of colors emitted from the laser 101 have large length-width ratios and matches less well with the light spots required by a subsequent light receiving member (such as the light homogenizing member 210). Herein, a length of the light spot may refer to a size of the light spot in the first direction X, and a width of the light spot may refer to a size of the light spot in the second direction Y.

In some embodiments, the beam reshaping member 102 may diffract the laser light, so that the shape of the light spot of the outgoing laser light meets the requirements. For example, the beam reshaping member 102 is configured to diffract the received laser light to adjust the light spot formed by the laser light transmitted from the beam reshaping member 102 to a light spot matching a shape of the light spot required by the light receiving member. For example, the length-width ratio (e.g., 16:9, 1:1, or other ratio) of the light spot required by the light receiving member is small, which is not limited by the present disclosure.

The plurality of beam reshaping regions in the beam reshaping member 102 are configured to shrink the laser light in the first direction X to reduce the size of the light spot formed by the laser light transmitted from the beam reshaping member 102 in the first direction X, thereby reducing the length-width ratio of the light spot, making the shape of the light spot approximate to a required shape, and improving the matching degree between the shape of the light spot and the required shape. Alternatively, the plurality of beam reshaping regions are configured to expand the laser light in the second direction Y to increase the size of the light spot formed by the laser light transmitted from the beam reshaping member 102 in the second direction Y, thereby reducing the length-width ratio of the light spot. Alternatively, the plurality of beam reshaping regions are configured to shrink the laser light in the first direction X and expand the laser light in the second direction Y. Alternatively, the plurality of beam reshaping regions are configured to shrink the laser light in the first direction X and the second direction Y, and a shrinkage degree of the laser light in the first direction X is greater than a shrinkage degree of the laser light in the second direction Y. For example, a reduction ratio of the laser light in the first direction X is greater than a reduction ratio of the laser light in the second direction Y. Alternatively, the plurality of beam reshaping regions are configured to expand the laser light in the first direction X and the second direction Y, and an expansion degree of the laser light in the first direction X is less than an expansion degree of the laser light in the second direction Y. For example, a magnification of the laser light in the first direction X is less than a magnification of the laser light in the second direction Y.

It should be noted that, in order to transmit the laser light in a miniaturized member, a beam shrinking member (such as a converging lens) is usually provided on the light outgoing side of the laser to shrink the laser light and reduce the size of the light beam to be subsequently transmitted. However, in some embodiments of the present disclosure, by providing the plurality of beam reshaping regions in the beam reshaping member 102 to shrink the laser light in the first direction X and the second direction Y respectively, the light source 10 does not need to be provided with a beam shrinking member, which further simplifies the structure of the light source 10 and facilitates the miniaturization of the projection device 1000.

In some embodiments, the shape of the light spot required by the light receiving member is rectangular. The plurality of light beam reshaping regions in the beam reshaping member 102 are configured to diffract the received laser light, so that the shape of the light spots formed by the laser light transmitted through the plurality of light beam reshaping regions is rectangular. Since the laser light of the plurality of colors respectively passing through the plurality of beam reshaping regions can be directed to the same region to be combined, the laser light of the plurality of colors emitted from the laser 101 after passing through the beam reshaping member 102 can form rectangular light spots respectively. In this way, when the light homogenizing member 210 is a light guide, the shape of the light spot formed by the laser light incident on the light guide has a high matching degree with the shape of a light inlet of the light guide, so that the light receiving effect of the light homogenizing member 210 is good, thereby improving the utilization rate and homogenizing effect of the laser light by the light homogenizing member 210. In some embodiments, the beam reshaping member 102 may alternatively adjust the received plurality of sub-beams respectively through the plurality of sub-beam reshaping regions therein, so that the light spots formed by the plurality of sub-beams transmitted from the beam reshaping member 102 are rectangular.

In some embodiments, the beam reshaping member 102 may further diffract the laser light, so that the energy distribution of the outgoing laser light is uniform.

Each of the plurality of sub-beams directed to the beam reshaping member 102 is a Gaussian beam, the energy (e.g., amplitude) in the sub-beam is Gaussian distributed, and the light spot formed by the sub-beam has a high central brightness and a low edge brightness. The plurality of beam reshaping regions in the beam reshaping member 102 can adjust the energy distribution of the received laser light, so that after the laser light of the plurality of colors emitted from the laser 101 are diffracted by the plurality of beam reshaping regions in the beam reshaping member 102, an energy difference (such as illumination or brightness) between any two positions of each of the light spots formed by the laser light of the plurality of colors may be less than an energy threshold, so that the energy distribution of the laser light transmitted from the beam reshaping member 102 is uniform. For example, the laser light transmitted from the beam reshaping member 102 may form a plurality of rectangular spots with uniform brightness at a plurality of positions.

Generally, in order to adjust the shape of the light spot of the laser light emitted from the laser to the required shape, a corresponding lens needs to be provided in the light source. In addition, in order to homogenize the laser light emitted from the laser, it is necessary to provide a member such as a diffusion sheet in the light source. However, in some embodiments of the present disclosure, the combination, shaping, and homogenization of the laser light of the plurality of colors emitted from the laser 101 can be achieved through one beam reshaping member 102. In this way, there is no need to provide components such as corresponding lenses and diffusers, which can reduce the number of components in the light source 10, simplify the structure and preparation process of the light source 10, and facilitate miniaturization of the light source 10.

The beam reshaping member 102 in some embodiments of the present disclosure is described in detail below with reference to the accompanying drawings.

In some embodiments, the beam reshaping member 102 may be a grating waveguide. The grating waveguide includes a coupling-in grating, an optical waveguide, and a coupling-out grating, and the diffraction microstructure in the beam reshaping member 102 refers to a microstructure in the coupling-in grating and a microstructure in the coupling-out grating. The coupling-in grating is configured to diffract the received laser light in the first direction and transmit the diffracted laser light to the optical waveguide. The optical waveguide is configured to transmit laser light from the coupling-in grating to the coupling-out grating. The coupling-out grating is configured to diffract the received laser light in the second direction and transmit the diffracted laser light out of the grating waveguide. The first direction is perpendicular to the second direction. Each beam reshaping region in the beam reshaping member 102 may include a first region in the in-coupling grating and a second region in the out-coupling grating.

Herein, the first direction and the second direction are only used to indicate that the coupling-in grating and the coupling-out grating process the laser light in two different directions, respectively, and the first direction and the second direction may be the same as the first direction X and the second direction Y in FIG. 7 and FIG. 9. Alternatively, the first direction may be the second direction Y in FIG. 7 and FIG. 9, and the second direction is the first direction X in FIG. 7 and FIG. 9, which is not limited in the present disclosure.

In addition, an irradiation region of the laser light of each color in the coupling-in grating may be referred to as a first region corresponding to the laser light, an irradiation region of the laser light of each color in the coupling-out grating may be referred to as a second area corresponding to the laser light, and a beam reshaping region corresponding to the laser light of each color in the beam reshaping member 102 includes the first area and the second area. Similarly, an irradiation region of each sub-beam in the coupling-in grating may be referred to as a first sub-region corresponding to the sub-beam, an irradiation region of each sub-beam in the coupling-out grating may be referred to as a second sub-region corresponding to the sub-beam, and a sub-beam reshaping region corresponding to each sub-beam in the beam reshaping member 102 includes the first sub-region and the second sub-region.

FIG. 10 is a schematic structural view of a light source according to other embodiments. In some embodiments, as shown in FIG. 10, the beam reshaping member 102 (i.e., the grating waveguide) includes a coupling-in grating 1021, a first optical waveguide 1022, and a coupling-out grating 1023. The diffraction microstructures 1024 in the beam reshaping member 102 are microstructures in the coupling-in grating 1021 and the coupling-out grating 1023. The coupling-in grating 1021, the first optical waveguide 1022, and the coupling-out grating 1023 may be integrated, or may be independent parts fixed together by attachment.

The first optical waveguide 1022 is plate-shaped and has two large plate surfaces (i.e., a first plate surface 1022A and a second plate surface 1022B) opposite to each other. The coupling-in grating 1021 is located on a first plate surface 1022A of the first optical waveguide 1022 away from the laser 101, and the coupling-out grating 1023 is located on a second plate surface 1022B of the first optical waveguide 1022 adjacent to the laser 101. In a thickness direction of the first optical waveguide 1022 (i.e., a direction HF in FIG. 10), an orthographic projection of the coupling-in grating 1021 on the first optical waveguide 1022 may be located outside an orthographic projection of the coupling-out grating 1023 on the first optical waveguide 1022. The coupling-in grating 1021 and the coupling-out grating 1023 may be reflection gratings.

The laser light emitted from the laser 101 can be incident on the coupling-in grating 1021 through the first optical waveguide 1022, and is reflected back to the first optical waveguide 1022 after being diffracted at the coupling-in grating 1021. The laser light reflected back to the first optical waveguide 1022 is totally reflected in the first optical waveguide 1022 and enters the coupling-out grating 1023, and is diffracted by the coupling-out grating 1023 and then is transmitted out of beam reshaping member 102 from the first optical waveguide 1022, thereby completing the adjustment of the received laser light by the beam reshaping member 102.

Continuing to refer to FIG. 10, the diffraction microstructures 1024 in the beam reshaping member 102 may be sawtooth-shaped, and the coupling-in grating 1021 and the coupling-out grating 1023 may each include a plurality of sawtooth-shaped diffraction microstructures 1024. In some embodiments, the diffraction microstructure 1024 may be strip-shaped, and a length direction of the diffraction microstructure 1024 in the coupling-in grating 1021 may be perpendicular to a length direction of the diffraction microstructure 1024 in the coupling-out grating 1023. For example, the length direction of the diffraction microstructure 1024 in the coupling-in grating 1021 is the first direction, and the length direction of the diffraction microstructure 1024 in the coupling-out grating 1023 is the second direction. In different beam reshaping regions of the beam reshaping member 102, apex angles of the sawtooth-shaped diffraction microstructures 1024 may be different, so as to achieve different processing of the received laser light in different beam reshaping regions. The apex angle refers to an angle between the two tooth surfaces of the sawtooth, such as an angle α in FIG. 10. The apex angles of the diffraction microstructures 1024 are different, and the corresponding grating thicknesses are also different. For example, the diffraction microstructures 1024 have different widths in different beam reshaping regions to achieve different processing of the received laser light in different beam reshaping regions. The width of the diffraction microstructure 1024 may be a width D1 in FIG. 10, which is a grating pitch of the grating and may also be referred to as a grating constant.

For example, at least one of the apex angles or the widths of the diffraction microstructures 1024 in different first regions of the coupling-in grating 1021 are different, and at least one of the apex angles or the widths of the diffraction microstructures 1024 in different second regions of the coupling-out grating 1023 are different. For another example, at least one parameter of the apex angle or the width of the diffraction microstructure 1024 in different first sub-regions of the coupling-in grating 1021 is different, and at least one parameter of the apex angle or the width of the diffraction microstructure 1024 in different second sub-regions of the coupling-out grating 1023 is different.

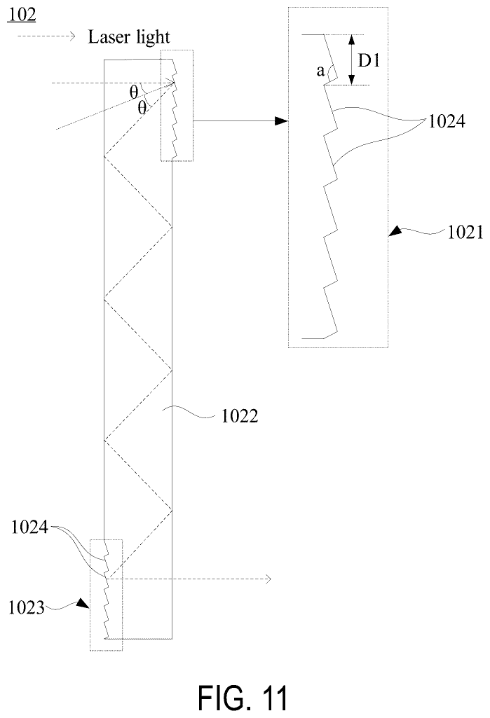

FIG. 11 is a schematic structural view of a beam reshaping member of the light source of FIG. 10. The laser light diffracted by the diffraction microstructures 1024 has a plurality of diffraction energy levels, and a state in which the diffraction energy level is 0 corresponds to the laser light being reflected. In FIG. 11, taking the incident angle of the laser light on one diffraction microstructure 1024 as an angle θ and the width of the diffraction microstructure 1024 as the width D1 as an example, a transmission direction of the laser when the diffraction energy level is 0 is illustrated. As shown in FIG. 11, the outgoing angle of the laser light is also the angle θ. The laser light and diffraction microstructure 1024 may satisfy the following formula (1): D1×sin2θ=m×λ, where m is an integer and represents a diffraction energy level (also referred to as a grating level), λ represents a wavelength of the laser light, D1 represents a width (i.e., a grating constant) of the required diffraction microstructure 1024, θ represents an outgoing angle (i.e., a diffraction angle) of the required laser light, and different diffraction energy levels m correspond to different outgoing angles θ of the laser light. In the case that a wavelength of an incident laser light is 525nm and the outgoing angle θ of the laser light needs to satisfy 2θ=45°, then D1 =1.3468 um.

In this way, the gratings (such as the coupling-in grating 1021 and the coupling-out grating 1023) can be designed based on the relationship (such as the formula (1)), so that the energy of the incident laser light is uniformly distributed on a plurality of diffraction energy levels after the incident laser light is diffracted, thereby achieving the expansion of the laser light. The energy of the incident laser may alternatively be distributed only at a certain diffraction energy level after the incident laser light is diffracted, so as to shrink the laser light.

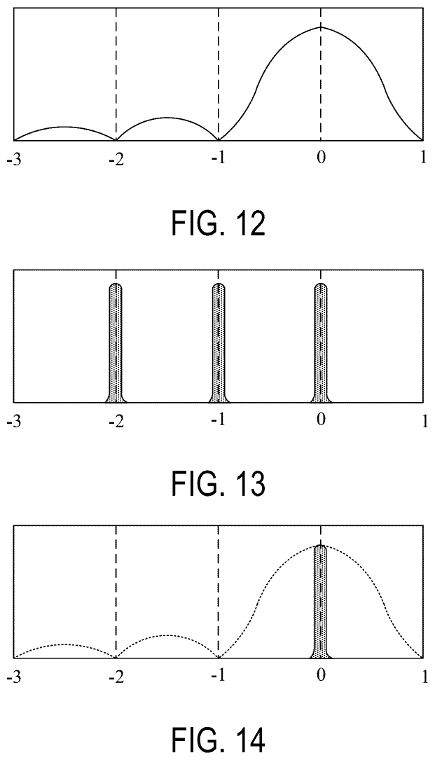

FIG. 12 is an energy distribution diagram of laser light according to some embodiments, FIG. 13 is an energy distribution diagram of laser light according to other embodiments, and FIG, FIG. 14 is an energy distribution diagram of laser light according to yet other embodiments. The abscissa represents the diffraction energy level and the ordinate represents the energy of the laser light. FIG. 12 shows the energy distribution when the laser light is incident on the grating, and the energy distribution is a Gaussian distribution. FIG. 13 shows the energy distribution when the laser light is transmitted out of one grating. As shown in FIG. 13, the grating enables the energy of the laser light to be uniformly distributed at each diffraction energy level, so as to expand the laser light. In this case, the grating may be a multi-level grating. FIG. 14 shows the energy distribution when the laser light is transmitted out of another grating. As shown in FIG. 14, the grating enables the energy of the laser light to be concentrated at one diffraction energy level, thereby achieving the shrinkage of the laser light. In this case, the grating may be a grating of a certain level, and the laser light can be concentrated on different diffraction energy levels by adjusting the grating level.

In some embodiments of the present disclosure, the diffraction microstructure 1024 may also be rectangular protrusions. For example, the diffraction microstructure 1024 is columnar and has a rectangular cross-section. The cross-section of the diffraction microstructure 1024 may be in other shapes. The structures of the coupling-in grating 1021 and the coupling-out grating 1023 may alternatively be similar to blazed gratings, and the cross-section of the diffraction microstructure 1024 may be triangular, which is not limited in the present disclosure.

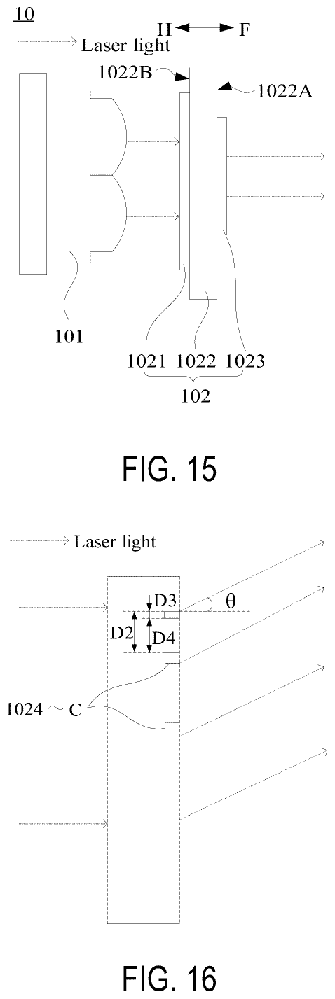

FIG. 15 is a schematic structural view of a light source according to yet other embodiments. In other embodiments, as shown in FIG. 15, the beam reshaping member 102 includes the coupling-in grating 1021, the first optical waveguide 1022, and the coupling-out grating 1023. The coupling-in grating 1021 is provided on the second plate surface 1022B of the first optical waveguide 1022 adjacent to the laser 101, and the coupling-out grating 1023 is provided on the first plate surface 1022A of the first optical waveguide 1022 away from the laser 101. In the thickness direction of the first optical waveguide 1022, the orthographic projection of the coupling-in grating 1021 on the first optical waveguide 1022 and the orthographic projection of the coupling-out grating 1023 on the first optical waveguide 1022 may at least partially overlap. The coupling-in grating 1021 and the coupling-out grating 1023 may be transmissive gratings.

The description of the plurality of beam reshaping regions of the beam reshaping member 102 in FIG. 15 and the effect on the laser light can make reference to the description related to FIG. 10, which will not be described herein again. In the thickness direction of the first optical waveguide 1022, the orthographic projection of the coupling-in grating 1021 on the first optical waveguide 1022 may not overlap with the orthographic projection of the coupling-out grating 1023 on the first optical waveguide 1022.

The diffraction microstructures 1024 in the coupling-in grating 1021 and the coupling-out grating 1023 in FIG. 15 may include grooves (e.g., notches). The groove may not be light-transmissive, and a portion between adjacent grooves is equivalent to a slit, which is light-transmissive.

FIG. 16 is a partial schematic structural view of a beam reshaping member of the light source of FIG. 15, and FIG. 16 shows a partial structure of the coupling-in grating 1021 or the coupling-out grating 1023. For example, as shown in FIG. 16, the laser light incident on the coupling-in grating 1021 or the coupling-out grating 1023 is diffracted by the coupling-in grating 1021 or the coupling-out grating 1023, and then the direction of the laser light is changed. The laser light and diffraction microstructure 1024 satisfies the following formula (2): D2×π×sinθ=m×λ, where m represents a diffraction energy level, λ represents a wavelength of the laser light, θ represents a diffraction angle of the laser light, D2 represents a distance (i.e., a grating constant) between adjacent grooves C, and different diffraction energy levels m correspond to different diffraction angle θ of the laser light. As shown in FIG. 16, the distance D2 between adjacent grooves C is equal to the sum of a width D3 of one of the grooves C and the minimum distance D4 between the adjacent grooves C.

The gratings (such as the coupling-in grating 1021 and the coupling-out grating 1023) can be designed based on the relationship (such as the formula (2)), so that the energy of the incident laser light is uniformly distributed on a plurality of diffraction energy levels after the incident laser light being diffracted, thereby achieving the expansion of the laser light. Alternatively, the energy of the incident laser may be distributed only at a certain diffraction energy level after the incident laser light is diffracted, so as to shrink the laser light, which can can make reference to the description related to FIG. 12 to FIG. 14, and are not described herein again.

It should be noted that the coupling-in grating 1021 and the coupling-out grating 1023 may also be located on the same plate surface of the first optical waveguide 1022. One of the coupling-in grating 1021 and the coupling-out grating 1023 is a transmission grating, and the other is a reflection grating. The structure of the transmission grating and the reflection grating can make reference to the description of the reflection grating in FIG. 10 and the description of the transmission grating in FIG. 15.

In other embodiments, the beam reshaping member 102 may be a diffractive optical element (DOE). The diffractive optical element is a two-dimensional diffractive device, which can adjust the laser light incident thereon directly in two directions. For example, the diffractive optical element directly diffracts the laser light incident thereon in the first direction and the second direction, respectively, so that the laser light transmitted from the diffractive optical element can be adapted to a required light spot.

For example, the diffractive optical element may include a plurality of diffraction microstructures distributed in two dimensions formed by a micro-nano etching process, each of the diffraction microstructures has a specific morphology and a refractive index, and the fine regulation of the laser may be achieved through the plurality of diffraction microstructures. For example, each diffraction microstructure is rectangular, sizes and depths (or heights) of the plurality of diffraction microstructures may be different, and distances between different diffraction microstructures may be different, so as to achieve targeted adjustment of the incident laser light. For example, the beam reshaping member 102 is a holographic optical element (HOE).

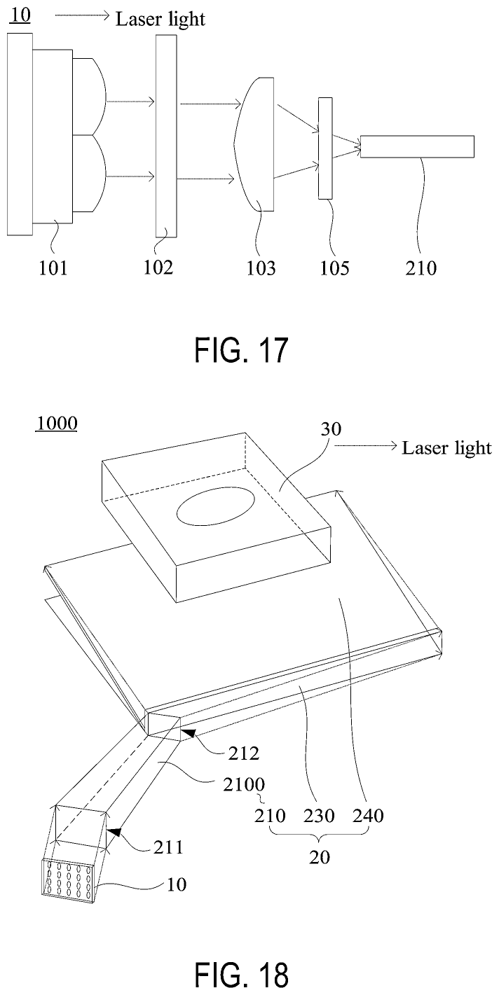

FIG. 17 is a schematic structural view of a light source according to yet other embodiments. In some embodiments, as shown in FIG. 17, in addition to components included in any of the light sources 10 described above, the light source 10 further includes a converging lens 103. The laser light transmitted from the beam reshaping member 102 may be directed to the converging lens 103 to be converged by the converging lens 103 to the light homogenizing member 210. The converging lens 103 is configured to converge the laser light, so that more laser light can be incident into the light homogenizing member 210, thereby improving the utilization rate of the laser light. The converging lens 103 may include one or more lenses. In practical applications, an appropriate number and type of lenses may be used as required.

In some embodiments, with continued reference to FIG. 17, the light source 10 further includes a diffusion sheet 105 located between the converging lens 103 and the light homogenizing member 210. The diffusion sheet 105 is configured to homogenize an incident light beam, thereby eliminating speckle. The diffusion sheet 105 may be stationary or may be movable. For example, the light source 10 further includes a rotating shaft that extends through a center of the diffusion sheet 105 and is perpendicular to the diffusion sheet 105, and the diffusion sheet 105 can rotate along the rotating shaft, so that the laser light is incident on different positions of the diffusion sheet 105 at different times, and divergence angles of the laser light at different times are different. Alternatively, the diffusion sheet 105 may reciprocate in a direction parallel to a plane where the diffusion sheet 105 is located.

In the light source of some embodiments of the present disclosure, each beam reshaping region in the beam reshaping member 102 may utilize the diffraction microstructure 1024 therein to diffract the received laser light, and the diffraction microstructures 1024 in different beam reshaping regions may be different, so that the light spots formed by the laser light of a plurality of colors emitted from the laser 101 after passing through the plurality of beam reshaping regions may coincide. In this way, the laser light of the plurality of colors emitted from the light source 10 have a good combination effect, a color uniformity of a projection image formed by the laser light emitted from the light source 10 is high, and a display effect of the projection image is good.

In addition, by providing one beam reshaping member 102 on the light outgoing side of the laser 101, light combining of a plurality of colors of lasers can be achieved without providing a plurality of light combining lenses, which can simplify the structure of the light source 10 and facilitate the miniaturization of the projection device 1000.

As described above, the lens assembly 220 and the prism assembly 250 are provided in the projection device 1000. In some embodiments, the optical modulating assembly 20 may include a volume grating to adjust the illumination beam, thereby omitting the aforementioned components (e.g., the lens assembly 220 and the prism assembly 250), reducing a volume of an illumination system in the projection device 1000, and facilitating miniaturization of the projection device 1000. The illumination system may refer to relevant optical components in the optical modulating assembly 20 for shaping the illumination beam to be adapted to the light valve 240.

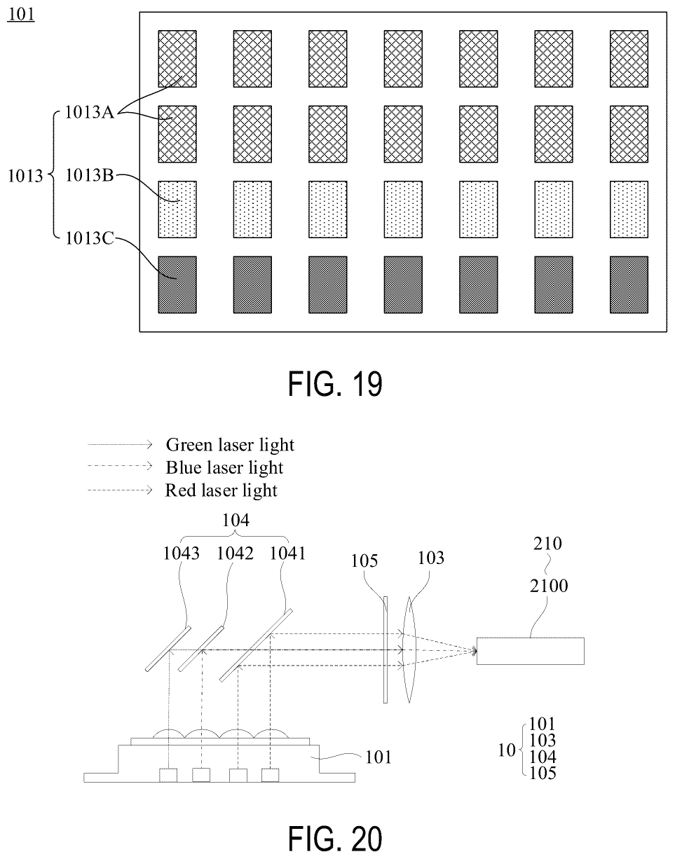

FIG. 18 is a perspective view of a projection device according to other embodiments. FIG. 19 is a schematic structural view of a laser according to yet other embodiments.

As shown in FIG. 18, the projection device 1000 includes a light source 10, an optical modulating assembly 20, and a lens 30. The optical modulating assembly 20 includes a light homogenizing member 210, a volume grating 230, and a light valve 240 (e.g., a DMD). The light homogenizing member 210 may be the wedge-shaped light guide 2100 described above. The illumination beam from the light source 10 enters the light guide 2100 through the first end 211 of the light guide 2100 to be homogenized, and is transmitted from the second end 212 of the light guide 2100 toward the volume grating 230 after being homogenized. The light valve 240 is located on the light outgoing side of the volume grating 230 and is configured to receive an illumination beam from the volume grating 230 and modulate the illumination beam to obtain a projection beam. It should be noted that the relevant contents of the light homogenizing member 210 and the light valve 240 can make reference to the foregoing, and are not described herein again.

The structure of the light source 10 will be described below by taking the laser 101 shown in FIG. 19 as an example. It should be noted that the laser 101 in FIG. 19 includes a plurality of light emitting chips 1013 arranged in a matrix array of 4 rows and 7 columns. The plurality of light emitting chips 1013 includes a plurality of first light emitting chips 1013A, a plurality of second light emitting chips 1013B, and a plurality of third light emitting chips 1013C. The plurality of first light emitting chips 1013A emit red laser light and are arranged in a matrix array of 2 rows and 7 columns. The plurality of second light emitting chips 1013B emit blue laser light, the plurality of third light emitting chips 1013C emit green laser light, and the plurality of second light emitting chips 1013B and the plurality of third light emitting chips 1013C are each arranged in a matrix array of 1 row and 7 columns. The number and arrangement of the laser 101 and the plurality of light emitting chips 1013 are not limited thereto. For example, the positions of the plurality of second light emitting chips 1013B and the plurality of third light emitting chips 1013C in FIG. 19 are interchanged.

FIG. 20 is a schematic structural view of a light source according to yet other embodiments.

In some embodiments, as shown in FIG. 20, the light source 10 further includes a first light combining mirror assembly 104. The first light combining mirror assembly 104 is located on a light outgoing side of the plurality of first light emitting chips 1013A, the plurality of second light emitting chips 1013B, and the plurality of third light emitting chips 1013C, and is configured to combine the red laser light, the green laser light, and the blue laser light. The light guide 2100 (the light homogenizing member 210) is located on the light outgoing side of the first light combining mirror assembly 104. The light guide 2100 may be a light guide having the same cross-sectional area.

The first light combining mirror assembly 104 may include a first light combining mirror 1041, a second light combining mirror 1042, and a third light combining mirror 1043. The third light combining mirror 1043 is located on the light outgoing side of the plurality of third light emitting chips 1013C. The third light combining mirror 1043 may be a reflection mirror, and is configured to reflect the green laser light emitted from the plurality of third light emitting chips 1013C to the second light combining mirror 1042.

The second light combining mirror 1042 is located on the light outgoing side of the plurality of second light emitting chips 1013B and on the light outgoing side of the third light combining mirror 1043. For example, the second light combining mirror 1042 is located at the intersection of the light reflected by the third light combining mirror 1043 and the light emitted from the plurality of second light emitting chips 1013B. The second light combining mirror 1042 may be a dichroic mirror, and is configured to transmit the green laser light reflected by the third light combining mirror 1043 and reflect the blue laser light emitted from the plurality of second light emitting chips 1013B, so as to combine the blue laser light and the green laser light. The first light combining mirror 1041 is located on the light outgoing side of the

plurality of first light emitting chips 1013A and on the light outgoing side of the second light combining mirror 1042. For example, the first light combining mirror 1041 is located at the intersection of the light emitted from the plurality of first light emitting chips 1013A and the light transmitted from the second light combining mirror 1042. The first light combining mirror 1041 may be a dichroic mirror, and is configured to transmit the blue laser light and the green laser light transmitted from the second light combining mirror 1042, and to reflect the red laser light emitted from the plurality of first light emitting chips 1013A, so as to combine the blue laser light, the green laser light, and the red laser light. It should be noted that the function of the plurality of light combining mirrors is not limited thereto. For example, in the case where the positions of the plurality of second light emitting chips 1013B and the plurality of third light emitting chips 1013C in FIG. 19 are interchanged, the third light combining mirror 1043 may be configured to reflect the blue laser light, and the second light combining mirror 1042 may be configured to reflect the green laser light and to transmit the blue laser light.

In some embodiments, as shown in FIG. 20, the light source 10 further includes a diffusion sheet 105 and a converging lens 103. The diffusion sheet 105 and the converging lens 103 are located between the first light combining mirror assembly 104 and the light guide 2100.

Moreover, the diffusion sheet 105 is located on the light outgoing side of the first light combining mirror assembly 104, and the converging lens 103 is located on the light outgoing side of the diffusion sheet 105. The related functions of the diffusion sheet 105 and the converging lens 103 can be referred to the related contents above, and are not described herein again.

The volume grating 230 in some embodiments of the present disclosure is described in detail below.

As shown in FIG. 18, the volume grating 230 is located on the light outgoing side of the light homogenizing member 210, and is configured to diffract incident light (e.g., an illumination beam).

The volume grating 230 refers to a diffraction element formed by the entire volume of

an element that can modulate incident light by periodically changing the refractive index or periodically absorbing light of a specific wavelength. For example, the volume grating 230 is a grating having a periodic refractive index, also referred to as a volume phase grating, and the refractive index at different portions of the volume grating 230 varies periodically.

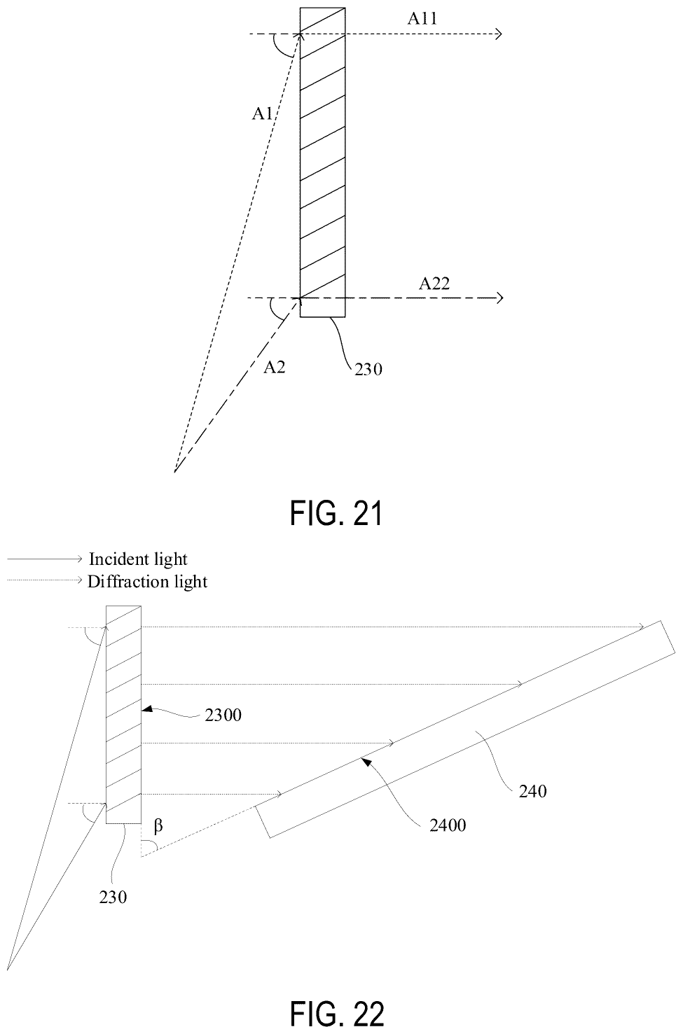

It should be noted that, in general, a light beam can be diffracted after being incident on a thin diffraction grating, and two light beams (i.e., a transmitted light beam and a diffracted light beam) are formed. After the light beam is incident on the volume grating 230 and diffracted, only one light beam is formed. FIG. 21 is a diffraction diagram of a volume grating according to some embodiments. For example, as shown in FIG. 21, a first light beam A1 is incident on the volume grating 230 and diffracted to form a first diffracted light beam A11, and a second light beam A2 is incident on the volume grating 230 and diffracted to form a second diffracted light beam A22.

A diffraction efficiency is a ratio of an optical power of the diffracted light to an optical power of the incident light. When the diffraction efficiency reaches 100%, indicating that all incident light can be diffracted and transmitted. The diffraction efficiency may reach 100% only when the light of a set wavelength is incident on the volume grating 230 at a Bragg angle. When the incident angle or wavelength is deviated, the diffraction efficiency will be reduced or even zero.

Therefore, the volume grating 230 can be designed according to the above properties to obtain a great diffraction efficiency. In general, an incident angle of the light beam incident on the volume grating 230 can be determined, and the incident angle is related to the structure of the projection device 1000 and the divergence angle of the emitting light of the light guide 2100, and the laser light incident on the volume grating 230 can have three wavelength bands (e.g., wavelengths corresponding to the red laser light, the green laser light and the blue laser light). Therefore, when designing the volume grating 230, appropriate refractive index change, thickness and period can be selected according to the wavelength of the incident laser light and the incident angle of the incident laser light incident on the volume grating 230 at different positions, so that the three-color laser light can be completely diffracted after being incident on the volume grating 230 (i.e., the diffraction efficiency corresponding to all incident light is 100%), thereby avoiding crosstalk between light at different angles and different wavelengths and reducing the generation of unnecessary diffraction. The period of the volume grating 230 refers to a length from one refractive index change point to an adjacent refractive index change point in the volume grating 230.

In some embodiments, the volume grating 230 may employ a photopolymer film, for example, a polypropylene (PP) film. The photopolymer can be polymerized under the condition of illumination, so that the refractive index of the material after the reaction is changed. In this way, according to the design requirements of the volume grating 230, different positions of the photopolymer film are illuminated to different degrees to form gradient refractive index changes, so that the volume grating 230 has a relatively high diffraction efficiency for the incident three-color laser.

In some embodiments, the thickness of the volume grating 230 is on the order of wavelength. For example, the thickness of the volume grating 230 is an integer multiple of the wavelength of the laser light of the corresponding color. After the light beam transmitted from the light homogenizing member 210 is incident on the volume grating 230, the volume grating 230 can deflect, homogenize and amplify the light beam, so that the light beam becomes a surface light source with a larger area, and the diffracted light transmitted from the volume grating 230 is substantially parallel light and can be directly incident on the light valve 240. Therefore, compared with the projection device 1000 shown in FIG. 3, by using the volume grating 230, the size of the illumination system in the projection device 1000 can be greatly reduced, the volume of the projection device 1000 can be reduced, and the miniaturization of the projection device 1000 can be facilitated.

In some embodiments, the volume grating 230 is provided on a side of the light valve 240, and a predetermined angle is formed between a light outgoing surface of the volume grating 230 and a light incident surface of the light valve 240. Since the DMD is generally rectangular, that is, the light incident surface of the DMD is generally rectangular, the laser light from the light source needs to be incident on the DMD at a predetermined angle. Therefore, the light outgoing surface of the volume grating 230 and the light incident surface of the DMD may be arranged at a predetermined angle.

FIG. 22 is a schematic structural view of a volume grating and a light valve according to some embodiments. For example, as shown in FIG. 22, a predetermined angle β is formed between the light outgoing surface 2300 of the volume grating 230 and the light incident surface 2400 of the light valve 240. Since DMDs of different specifications have different requirements for the incident angle of light, the angle between the volume grating 230 and the DMD needs to be set according to the requirements of the DMD.

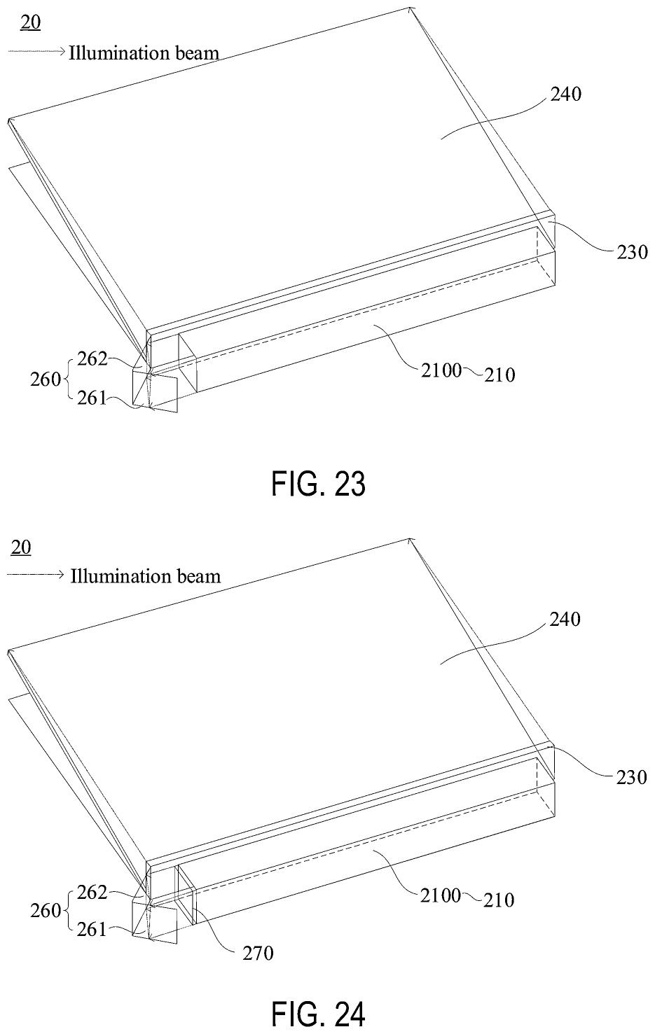

FIG. 23 is a perspective view of an optical modulating assembly in a projection device according to some embodiments. In some embodiments, as shown in FIG. 23, the volume grating 230 is located on a side edge of the light valve 240. The light guide 2100 is located on a side of the volume grating 230 away from the light valve 240, and the light guide 2100 extends in a direction parallel to the side edge of the light valve 240. In this case, the optical modulating assembly 20 further includes a reflection mirror assembly 260. The reflection mirror assembly 260 is provided on the light outgoing side of the light guide 2100, and the reflection mirror assembly 260 is configured to reflect the illumination beam transmitted from the light guide 2100 to the volume grating 230.

The reflection mirror assembly 260 may include one or more mirrors that may reflect red, green, and blue laser light. For example, as shown in FIG. 23, the reflection mirror assembly 260 includes two mirrors 261, 262 arranged at a predetermined angle therebetween. It should be noted that one, two, or more mirrors may be provided on the light outgoing side of the light guide 2100 according to an actual situation, which is not limited in the present disclosure.

It should be noted that a size and a position of the reflection mirror assembly 260 and an inclination angle of the illumination beam transmitted from the light guide 2100 with respect to the reflection mirror assembly 260 need to satisfy the condition that the illumination beam transmitted from the light guide 2100 is reflected to the light incident surface of the volume grating 230. Therefore, parameters such as the period, the thickness, and the refractive index change of the volume grating 230 can be designed according to the incident angle at which the illumination beam is reflected to the volume grating 230 by the reflection mirror assembly 260.

FIG. 24 is a perspective view of an optical modulating assembly in a projection device according to other embodiments. In some embodiments, as shown in FIG. 24, the optical modulating assembly 20 further includes one or more collimating lenses 270. The collimating lens 270 is located between the light guide 2100 and the reflection mirror assembly 260 and is configured to collimate an incident light beam. For example, the collimating lens 270 is attached to a light outlet of the light guide 2100. After being collimated by the collimating lens 270, the illumination beam transmitted from the light guide 2100 is incident on the reflection mirror assembly 260, and an incident angle of the illumination beam incident on the reflection mirror assembly 260 can be a fixed value, so that the incident angle of the illumination beam reflected by the reflection mirror assembly 260 to the volume grating 230 can also be a fixed value, which is conducive to simplifying the design difficulty of the volume grating 230.

In the case where the optical modulating assembly 20 includes one collimating lens 270, the structure of the optical modulating assembly 20 is simple, which facilitates miniaturization of the projection device 1000. In addition, by providing the collimating lens 270 at the light outlet of the light guide 2100, the divergence angle of the illumination beam transmitted from the light guide 2100 can be reduced, so as to facilitate determining the incident angle of the illumination beam incident on the volume grating 230.

It should be noted that in some embodiments of the present disclosure, the solution of achieving light homogenization using the volume grating 230 may also be applied to a liquid crystal display device. For example, the solution is applied to a backlight for a liquid crystal display panel.

In the foregoing description, the uniformity of the light spot is mainly adjusted by the grating as an example. In some embodiments, the projection device 1000 may also use an optical waveguide (such as an array optical waveguide or a sawtooth-shaped optical waveguide) to adjust the uniformity of the light spots of the laser light of a plurality of colors. The array optical waveguide or the sawtooth-shaped optical waveguide may be in the form of a sheet. For example, the array optical waveguide or the sawtooth-shaped optical waveguide is a transparent substrate with a high refractive index, the illumination beam emitted from the light source is coupled into a side of the substrate through a specific structure, the illumination beam is totally reflected and transmitted in the substrate, and the illumination beam is coupled out through another specific structure after being transmitted to a position.

The light source 10 having an optical waveguide in some embodiments of the present disclosure is described in detail below.

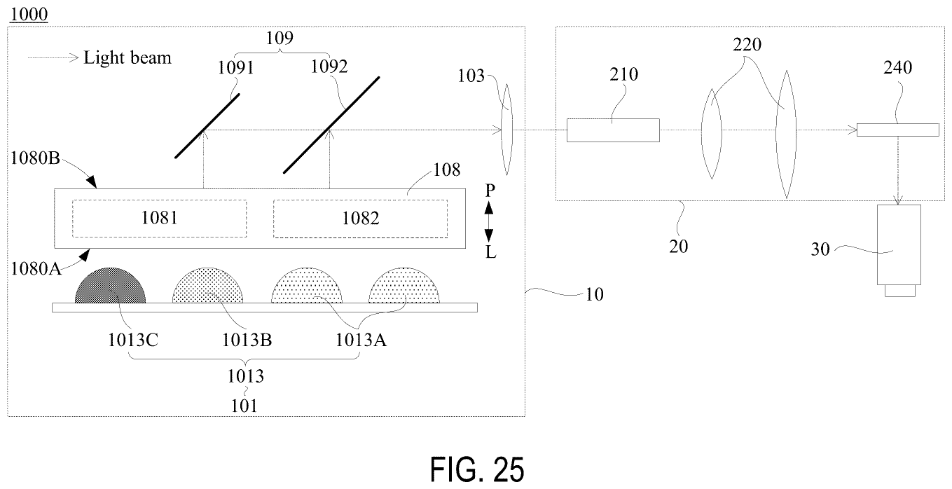

FIG. 25 is a schematic structural view of a projection device according to yet other embodiments. In some embodiments, the light source 10 may include a laser 101 and one or more second optical waveguides 108. The laser 101 shown in FIG. 19 is described below as an example.

The second optical waveguide 108 may be located on the light outgoing side of the third light emitting chip 1013C. The second optical waveguide 108 may include a light incident portion 1081 and a light outgoing portion 1082. The light incident portion 1081 is configured to introduce the incident laser light (e.g., at least one of the blue laser light or the green laser light) into the second optical waveguide 108. The light outgoing portion 1082 is configured to transmit the laser light in the second optical waveguide 108 out of the second optical waveguide 108. A beam width of at least one of the blue laser light and the green laser light transmitted from the light outgoing portion 1082 is equal to a beam width of the red laser light emitted from the first light emitting chip 1013A. The beam width may refer to a dimension of the light beam in a plane perpendicular to an axis of the light beam.

The second optical waveguide 108 may be made of a material having low optical transparency and transmission loss, such as glass, silicon dioxide, or lithium niobate. In addition, the light incident portion 1081 and the light outgoing portion 1082 of the second optical waveguide 108 have a film layer with a reflection or transmission function, so that the light incident into the second optical waveguide 108 transmitted in the second optical waveguide 108 along a predetermined path.

In some embodiments, as shown in FIG. 25, the second optical waveguide 108 includes a light incident surface 1080A and a light outgoing surface 1080B that are parallel to each other, and the light incident surface 1080A and the light outgoing surface 1080B are opposite to each other in a thickness direction (e.g., a direction PL in FIG. 25) of the optical waveguide 108. The light incident portion 1081 and the light outgoing portion 1082 of the optical waveguide 108 are located between the light incident surface 1080A and the light outgoing surface 1080B, respectively. The light incident surface 1080A of the optical waveguide 108 faces the laser 101.

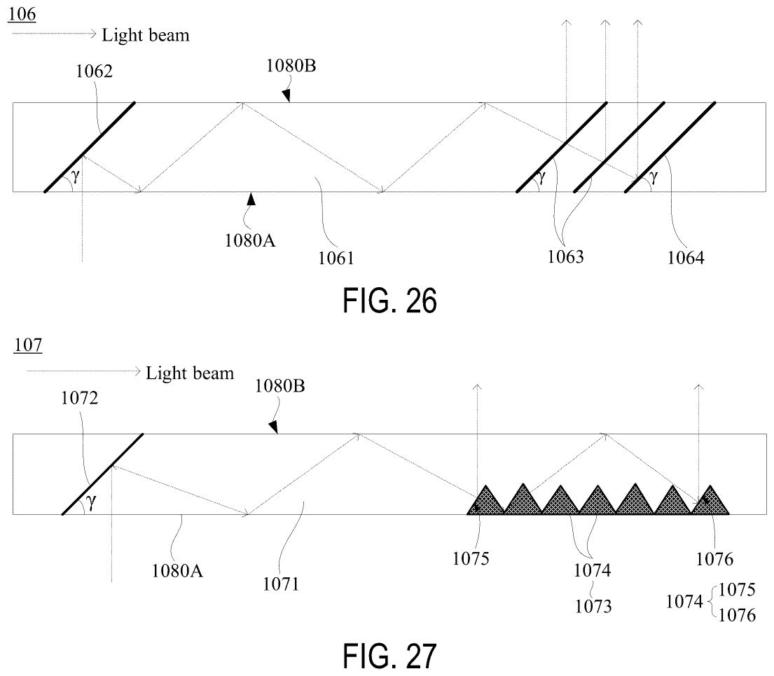

FIG. 26 is a schematic structural view of an array optical waveguide according to some embodiments. FIG. 27 is a schematic structural view of a sawtooth-shaped optical waveguide according to some embodiments. In some embodiments, the optical waveguide 108 may include an array optical waveguide 106 or a sawtooth-shaped optical waveguide 107.

For example, as shown in FIG. 26, the array optical waveguide 106 includes a first body 1061, a first reflection film 1062, one or more first transflective films 1063, and a second reflection film 1064. The first reflection film 1062, the first transflective film 1063, and the second reflection film 1064 are provided in the first body 1061. The first reflection film 1062 is located at one end of the first body 1061 to serve as a light incident portion of the array optical waveguide 106 (i.e., the light incident portion 1081 of the optical waveguide 108). The first transflective film 1063 and the second reflection film 1064 are located at the other end of the first body 1061 to serve as a light outgoing portion of the array optical waveguide 106 (i.e., the light outgoing portion 1082 of the optical waveguide 108). The first transflective film 1063 is located between the first reflection film 1062 and the second reflection film 1064.

The first reflection film 1062, the first transflective film 1063, and the second reflection film 1064 are parallel to each other, and are inclined at a predetermined angle γ with respect to the light incident surface 1080A of the optical waveguide 108. The predetermined angle γ satisfies the condition that the incident laser light is reflected and the laser light is totally reflected in the first body 1061.

The light beam incident on the light incident portion of the array optical waveguide 106 is reflected by the first reflection film 1062 and then is totally reflected multiple times in the first body 1061 to be transmitted. When the light beam passes through the first transflective film 1063, the first transflective film 1063 may reflect a first part of the light beam out of the array optical waveguide 106, and transmit a second part of the light beam to the next first transflective film 1063, until the light beam is transmitted to the second reflection film 1064, the second reflection film 1064 reflects all of the remaining light beams out of the array optical waveguide 106. It should be noted that the transmissivity and reflectivity of the light incident on the first transflective film 1063 can be changed by coating the first transflective film 1063, and the light beams that can be transmitted and reflected by the second transflective film 1064 can be changed by coating the second reflection film 1064.

By arranging a plurality of film layers in the array optical waveguide 106, the light beam in the array optical waveguide 106 can be divided into different parts to be transmitted, thereby expanding the light beam. In addition, by adjusting the number and positions of the first transflective films 1063 in the array optical waveguide 106, the size of the light beam (e.g., the beam width) transmitted from the array optical waveguide 106 can be adjusted. In addition, in the case where the array optical waveguide 106 includes a plurality of first transflective films 1063, by adjusting the reflectivity and transmissivity of the plurality of first transflective films 1063, light beams can be reflected multiple times in the array optical waveguide 106, and the uniformity of light beams transmitted from the array optical waveguide 106 can be improved.

For example, as shown in FIG. 27, the sawtooth-shaped optical waveguide 107 includes a second body 1071, a third reflection film 1072, and a prism portion 1073. The third reflection film 1072 and the prism portion 1073 are provided in the second body 1071. The third reflection film 1072 is located at one end of the second body 1071 to serve as a light incident portion of the sawtooth-shaped optical waveguide 107 (i.e., the light incident portion 1081 of the optical waveguide 108). The prism portion 1073 is located at the other end of the second body 1071 to serve as a light outgoing portion of the sawtooth-shaped optical waveguide 107 (i.e., the light outgoing portion 1082 of the optical waveguide 108).

The third reflection film 1072 is spaced apart from the prism portion 1073 by a predetermined distance, so as to allow the prism portion 1073 to transmit and reflect the laser light of the corresponding wavelength. The third reflection film 1072 is inclined at the predetermined angle γ with respect to the light incident surface 1080A of the optical waveguide 108. The predetermined angle γ satisfies the condition that the incident laser light is reflected and the laser light is totally reflected in the second body 1071.

The prism portion 1073 is located on the light incident surface 1080A of the optical waveguide 108. The prism portion 1073 may include a plurality of sub-prisms 1074 arranged in parallel. The sub-prisms 1074 may be strip-shaped. Among two or more sub-prisms 1074 adjacent to the third reflection film 1072, a second transflective film 1075 is provided on a surface of the sub-prism 1074 facing the third reflection film 1072. In one or more sub-prisms 1074 away from the third reflection film 1072, a fourth reflection film 1076 is provided on the surface of the sub-prism 1074 facing the third reflection film 1072. The number of the second transflective film 1075 and the fourth reflection film 1076 may be set according to actual needs.

The light beam incident on the light incident portion of the sawtooth-shaped optical waveguide 107 is reflected by the third reflection film 1072 and then is totally reflected multiple times in the second body 1071 to be transmitted. When the light beam passes through the second transflective film 1075 in the prism portion 1073, the second transflective t film 1075 may reflect a first part of the light beam out of the sawtooth-shaped optical waveguide 107, and transmit a second part of the light beam to the next second transflective film 1075, until the light beam is transmitted to the fourth reflection film 1076 and is reflected out of the sawtooth-shaped optical waveguide 107 by the fourth reflection film 1076.

By providing a plurality of film layers in the sawtooth-shaped optical waveguide 107, the light spot of the light beam transmitted from the sawtooth-shaped optical waveguide 107 can be expanded to the same width as the prism portion 1073, and the light beam can be homogenized.

By applying the array optical waveguide 106 and the sawtooth-shaped optical waveguide 107 to the projection device 1000, the laser light of different colors emitted from the light source 10 can be uniformly distributed, thereby improving the display effect of the projection image.

In some embodiments, the light source 10 may include an optical waveguide 108 located on the light outgoing side of the plurality of third light emitting chips 1013C. The optical waveguide 108 is configured to expand the beam width of the green laser light emitted from the third light emitting chip 1013C, so that the beam width of the green laser light transmitted from the light outgoing portion 1082 of the optical waveguide 108 is equal to the beam width of the red laser light emitted from the plurality of first light emitting chips 1013A.

The product of the size of the light spot and the divergence angle of the laser light determines the etendue of the laser light. For example, the smaller the beam width of the laser light, the smaller the etendue of the laser light. In addition, since the small etendue will lead to serious laser speckle phenomenon, and the etendue of the red laser light in the three-color laser projection device is usually greater than that of the blue laser light and the green laser light, the speckle phenomenon of the blue laser light and the green laser light is more obvious than that of the red laser light.

However, in some embodiments of the present disclosure, since the human eye is less sensitive to blue light, outgoing light can be uniform by making the beam widths of the green laser light and the red laser light the same. Further, by increasing the beam width of the green laser light, the etendue of the green laser light can be increased, so that the etendue of the green laser light is the same as the etendue of the red laser light, thereby reducing the speckle phenomenon of the green laser light. In this way, a better display effect can be achieved by using fewer optical components, and the miniaturization of the projection device 1000 is facilitated.

In some embodiments, as shown in FIG. 25, the light source 10 further includes a second light combining mirror assembly 109. The second light combining mirror assembly 109 is located on the light outgoing side of the laser 101 and the optical waveguide 108, and is configured to combine the red laser light, the green laser light and the blue laser light. The combined light beam can have good uniformity. For example, the second light combining mirror assembly 109 includes one or more reflection mirrors and one or more dichroic mirrors. The second light combining mirror assembly 109 may also be set according to specific light combining requirements.

In some embodiments, as shown in FIG. 25, the light source 10 further includes a light homogenizing member 210. The light homogenizing member 210 may be located on the light outgoing side of the second light combining mirror assembly 109, and is configured to homogenize the laser light combined by the second light combining mirror assembly 109, so as to make the energy distribution of the laser light is uniform and reduce the speckle. The related contents of the light homogenizing member 210 can be referred to the foregoing, and are not described herein again.

In some embodiments, as shown in FIG. 25, the light source further includes a converging lens 103 disposed on the light outgoing side of the second light combining mirror assembly 109 and configured to converge the incident light beam. The relevant contents of the converging lens 103 may be referred to the foregoing, and are not described herein again.

Several examples of light source 10 include one optical waveguide 108 in some embodiments of that present disclosure are described in detail below.

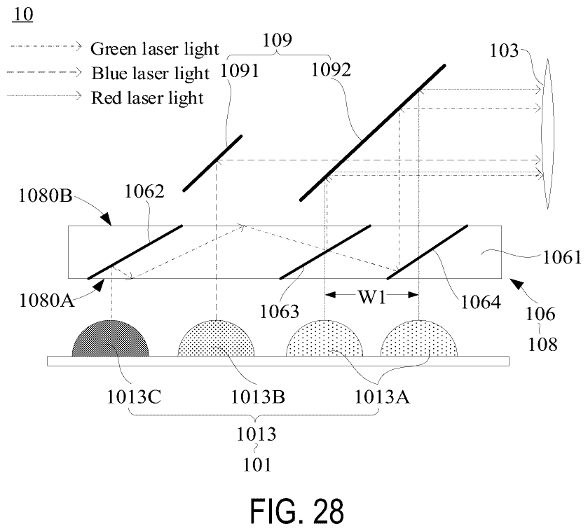

FIG. 28 is a light path diagram of a light source according to yet other embodiments. In some embodiments, as shown in FIG. 28, in the case where the optical waveguide 108 includes the array optical waveguide 106, the first reflection film 1062 is located on the light outgoing side of the third light emitting chip 1013C, and the first transflective film 1063 and the second reflection film 1064 are located on the light outgoing side of the first light emitting chip 1013A. The first transflective film 1063 is configured to reflect a first part of the green laser light and transmit a second part of the green laser light and the red laser light. The second reflection film 1064 is configured to reflect the green laser light and transmit the red laser light. The second reflection film 1064 serves as a dichroic mirror. A distance W1 between the first transflective film 1063 and the second reflection film 1064 is equal to the beam width of the red laser light emitted from the plurality of first light emitting chips 1013A. The beam width of the red laser light equal to the distance W1 may be understood as a corresponding dimension of the red laser light in the same direction as the distance W1, but is not limited thereto.

Continuing to refer to FIG. 28, the green laser light emitted from the third light emitting chip 1013C is incident on the first reflection film 1062. Since the inclination angle of the first reflection film 1062 with respect to the light incident surface 1080A satisfies the total reflection condition, after the green laser light is reflected to the light incident surface 1080A by the first reflection film 1062, the green laser light may be totally reflected multiple times between the light incident surface 1080A and the light outgoing surface 1080B in the first body 1061 and be incident on the first transflective film 1063. A first part of the green laser light is reflected out of the array optical waveguide 106 by the first transflective film 1063, and a second part of the green laser light is transmitted by the transflective film 1063 and continues to be transmitted in the first body 1061 until it is incident on the second reflection film 1064. The second reflection film 1064 reflects all of the incident green laser light out of the array optical waveguide 106.

In this case, the second light combining mirror assembly 109 may include a fourth light combining mirror 1091 and a fifth light combining mirror 1092. The fourth light combining mirror 1091 is located on the light outgoing side of the plurality of second light emitting chips 1013B, and is configured to reflect the blue laser light. The fifth light combining mirror 1092 is located on the light outgoing side of the array optical waveguide 106, and is configured to reflect the red laser light and the green laser light and transmit the blue laser light. The fourth light combining mirror 1091 and the fifth light combining mirror 1092 are arranged in parallel, and the two may be inclined by a preset angle with respect to a plane where the optical waveguide 108 is located.

In this way, the green laser light transmitted from the array optical waveguide 106 can be reflected to the converging lens 103 by the fifth light combining mirror 1092. The blue laser light emitted from the plurality of second light emitting chips 1013B can be directly transmitted by the array optical waveguide 106 and then incident to the fourth light combining mirror 1091, and reflected to the fifth light combining mirror 1092 by the fourth light combining mirror 1091. The blue laser light reflected to the fifth light combining mirror 1092 is transmitted to the converging lens 103 by the fifth light combining mirror 1092. The red laser light emitted from the plurality of first light emitting chips 1013A is transmitted by the array optical waveguide 106 to the fifth light combining mirror 1092, and is reflected by the fifth light combining mirror 1092 to the converging lens 103. The red, green, and blue laser light incident on the converging lens 103 are converged by the converging lens 103 to the light homogenizing member 210.

In some embodiments of the present disclosure, since the first transflective film 1063 and the second reflection film 1064 are respectively provided on the light outgoing sides of the two rows of first light emitting chips 1013A, and the green laser light is divided into two parts by the first transflective film 1063 and the second reflection film 1064 to be transmitted out of the array optical waveguide 106. Therefore, the beam width of the green laser light transmitted from the array optical waveguide 106 can be increased, and can be equal to the distance W1 between the first transflective film 1063 and the second reflection film 1064. In addition, since the first transflective film 1063 and the second reflection film 1064 may transmit the red laser light, the beam width of the red laser light emitted from the plurality of first light emitting chips 1013A may be equal to the distance W1 between the first transflective film 1063 and the second reflection film 1064. Therefore, the beam width of the green laser light may be equal to the beam width of the red laser light. Thus, the light beam emitted from the light source 10 is more uniform, and the etendue of the green laser light can be increased to be the same as the etendue of the red laser light, thereby reducing the speckle phenomenon of the green laser light.

It should be noted that the transmittance and the reflectance of the first transflective film 1063 can be changed according to the design requirements of the projection device 1000. In some embodiments, the transmittance of the first transflective film 1063 may be 50%, and the reflectance of the first transflective film 1063 may be 50%, so that the energy of the light beam of the green laser light transmitted from the first transflective film 1063 and the second reflection film 1064 is equal, thereby improving the uniformity of the light intensity distribution of the green laser light.

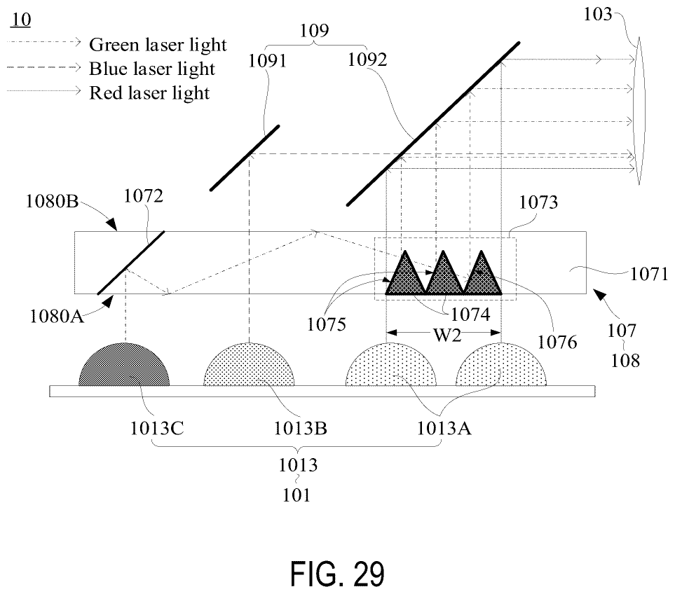

FIG. 29 is a light path diagram of a light source according to yet other embodiments. In other examples, as shown in FIG. 29, in the case where the optical waveguide 108 includes the sawtooth-shaped optical waveguide 107, the third reflection film 1072 is located on the light outgoing side of the plurality of third light emitting chips 1013C, and the prism portion 1073 is located on the light outgoing side of the first light emitting chip 1013A. The second transflective film 1075 is configured to reflect a first part of the green laser light and transmit a second part of the green laser light and the red laser light. A fourth reflection film 1076 is provided on a surface of the sub-prism 1074 that is farthest from the third reflection film 1072 and faces the third reflection film 1072, and is configured to reflect the green laser light and transmit the red laser light. The fourth reflection film 1076 serves as a dichroic mirror. The fourth reflection film 1076 can reflect all the light beams transmitted in the sawtooth-shaped optical waveguide 107 out of the sawtooth-shaped optical waveguide 107, thereby avoiding the loss of the light beam in the case of expanding the light beam. A width W2 of the prism portion 1073 is equal to the beam width of the red laser light emitted from the plurality of first light emitting chips 1013A.

Continuing to refer to FIG. 29, the green laser light emitted from the plurality of third light emitting chips 1013C are incident on the third reflection film 1072. Since the inclination angle of the third reflection film 1072 with respect to the light incident surface 1080A satisfies the total reflection condition, after the green laser light is reflected to the light incident surface 1080A by the third reflection film 1072, the green laser light can be totally reflected multiple times between the light incident surface 1080 A and the light-out surface 1080B in the second body 1071 and incident on the prism portion 1073. When the green laser light passes through the second transflective film 1075 on the sub-prism 1074, a first part of the green laser light may be reflected out of the sawtooth-shaped optical waveguide 107 by the second transflective film 1075, and a second part of the green laser light may be transmitted by the second transflective film 1075 and continue to be transmitted to the next sub-prism 1074. After repeating the above process for multiple times, the remaining green laser light is totally reflected out of the sawtooth-shaped optical waveguide by the fourth reflection film 1076.

In this case, the second light combining mirror assembly 109 may include a fourth light combining mirror 1091 and a fifth light combining mirror 1092. The structure and function of the second light combining mirror assembly 109 are similar to the structure and function of the second light combining mirror assembly 109 in FIG. 28, and are not described herein again.

Since the green laser light emitted from the plurality of third light emitting chips 101C is divided into a plurality of parts in the sawtooth-shaped optical waveguide 107 to be transmitted out of the sawtooth-shaped optical waveguide 107. Therefore, the beam width of the green laser light transmitted from the sawtooth-shaped optical waveguide 107 is increased, and can be equal to the width W2 of the prism portion 1073. Since the width of the prism portion 1073 is equal to the beam width of the red laser light emitted from the plurality of first light emitting chips 1013A, the beam widths of the green laser light and the red laser light may be equal. Thus, the light formed by the green laser light and the red laser light being combined by the second light combining mirror assembly 109 is relatively uniform, and the etendue of the green laser light can be increased to be the same as the etendue of the red laser light, so as to reduce the speckle phenomenon of the green laser light.

In some embodiments, the light source 10 may also include two optical waveguides 108.

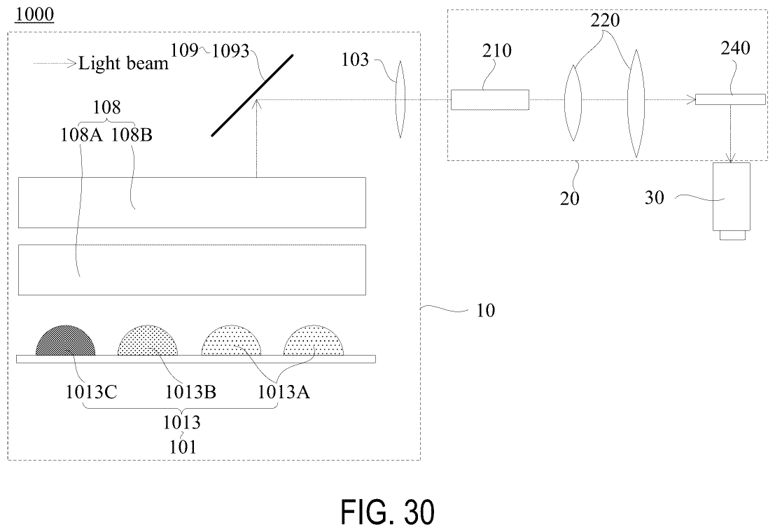

FIG. 30 is a schematic structural view of a projection device according to yet other embodiments. For example, as shown in FIG. 30, the light source 10 includes a first optical waveguide 108A and a second optical waveguide 108B. The first optical waveguide 108A is located on the light outgoing side of the plurality of third light emitting chips 1013C, and the second optical waveguide 108B is located on the light outgoing side of the plurality of second light emitting chips 1013B. The first optical waveguide 108A is configured to expand the beam width of the green laser light emitted from the plurality of third light emitting chips 1013C, and the second optical waveguide 108B is configured to expand the beam width of the blue laser light emitted from the plurality of second light emitting chips 1013B, so that the beam width of the green laser light transmitted from the first optical waveguide 108A and the beam width of the blue laser light transmitted from the second optical waveguide 108B are equal to the beam width of the red laser light emitted from the plurality of first light emitting chips 1013 A.

A configuration in which two optical waveguides 108 are provided in the projection device 1000 can be used in the case where the number of the second light emitting chips 1013B (such as the blue light emitting chips) in the laser 101 is small, so as to enlarge the beam widths of the blue and green laser light to be the same as the beam width of the red laser light, so that the light beam emitted from the light source 10 is uniformly distributed, and the problem that the color temperature and the color condition of a projection picture are abnormal due to the small beam width of the blue laser light can be avoided. In addition, the etendue of the blue laser light and the green laser light can be increased to be the same as the etendue of the red laser light, respectively, thereby reducing the speckle of the blue laser light and the green laser light.

The first optical waveguide 108 A and the second optical waveguide 108B may each be the array optical waveguide 106. Alternatively, the first optical waveguide 108 A and the second optical waveguide 108B may each be the sawtooth-shaped optical waveguide 107. Alternatively, the first optical waveguide 108A is the array optical waveguide 106, and the second optical waveguide 108B is the sawtooth-shaped optical waveguide 107. Alternatively, the first optical waveguide 108A is the sawtooth-shaped optical waveguide 107, and the second optical waveguide 108B is the array optical waveguide 106. The above four manners can expand the beam width of the blue laser and the green laser. Hereinafter, the first optical waveguide 108A and the second optical waveguide 108B are respectively described using the array optical waveguide 106 as an example.

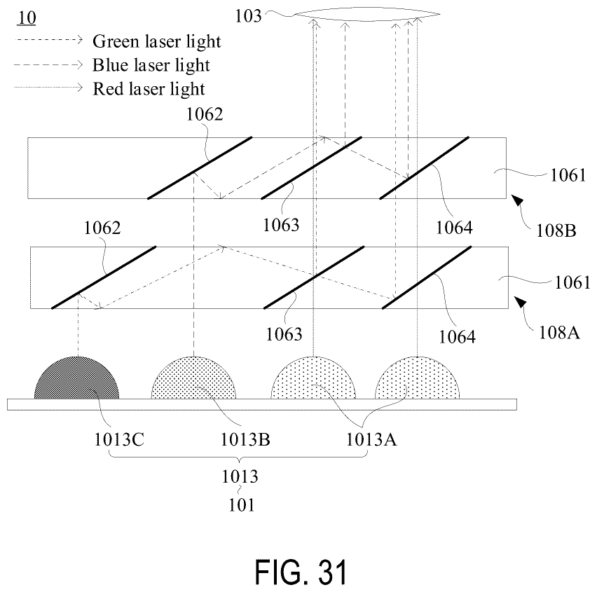

FIG. 31 is a light path diagram of a light source according to yet other embodiments. In some examples, as shown in FIG. 31, the first reflection film 1062 of the first optical waveguide 108A is located on the light outgoing side of the plurality of third light emitting chips 1013C, and the first transflective film 1063 and the second reflection film 1064 of the first optical waveguide 108A are located on the light outgoing side of the plurality of first light emitting chips 1013A. The structure and function of the plurality of film layers in the first optical waveguide 108A, can be referred to the related contents of the array optical waveguide 106 in FIG. 28, and are not described herein again.

The first reflection film 1062 of the second optical waveguide 108B is located on the light outgoing side of the plurality of second light emitting chips 1013B, and is configured to reflect the blue laser light emitted from the plurality of second light emitting chips 1013B. The first transflective film 1063 and the second reflection film 1064 of the second optical waveguide 108B are located on the light outgoing side of the plurality of first light emitting chips 1013A. The first transflective film 1063 of the second optical waveguide 108B is configured to reflect a first part of the blue laser light and transmit a second part of the blue laser light, the green laser light, and the red laser light. The second reflection film 1064 of the second optical waveguide 108B is configured to reflect the blue laser light and transmit the green laser light and the red laser light.

The first transflective film 1063 and the second reflection film 1064 of the second optical waveguide 108B serve as a dichroic mirror. The angles of the plurality of film layers in the second optical waveguide 108B can be referred to the foregoing description, and are not described herein again.

A distance between the first transflective film 1063 and the second reflection film 1064 in the first optical waveguide 108A, and a distance between the first transflective film 1063 and the second reflection film 1064 in the second optical waveguide 108B are equal to the beam width of the red laser light emitted from the plurality of first light emitting chips 1013A, respectively. In addition, the first transflective film 1063 in the first optical waveguide 108a may be parallel to the first transflective film 1063 in the second optical waveguide 108B, and the second reflection film 1064 in the first optical waveguide 108A may be parallel to the second reflection film 1064 in the second optical waveguide 108B.

The green laser light emitted from the plurality of third light emitting chips 1013C is incident on the first reflection film 1062 in the first optical waveguide 108A and is reflected by the first reflection film 1062. The green laser light reflected by the first reflection film 1062 is totally reflected multiple times in the first optical waveguide 108A, and is incident on the first transflective film 1063 in the first optical waveguide 108A. A first part of the green laser light is reflected out of the first optical waveguide 108A by the first transflective film 1063, and a second part of the green laser light is transmitted by the first transflective film 1063 and continues to be transmitted in the first optical waveguide 108A until it is incident on the second reflection film 1064 in the first optical waveguide 108A. The green laser light incident on the second reflection film 1064 is totally reflected out of the first optical waveguide 108A by the second reflection film 1064, and the beam width of the green laser light transmitted from the first optical waveguide 108A is equal to the beam width of the red laser light.

The blue laser light emitted from the plurality of second light emitting chips 1013B passes through the first optical waveguide 108A and is incident on the first reflection film 1062 in the second optical waveguide 108B, and is reflected by the first reflection film 1062. The blue laser light reflected by the first reflection film 1062 is totally reflected multiple times in the second optical waveguide 108B, and is incident on the first transflective film 1063 in the second optical waveguide 108B. A first part of the blue laser light is reflected out of the second optical waveguide 108B by the first transflective film 1063, and a second part of the blue laser light is transmitted by the first transflective film 1063 and continues to be transmitted in the second optical waveguide 108B until it is incident on the second reflection film 1064 in the second optical waveguide 108B. The blue laser light incident on the second reflection film 1064 is totally reflected out of the second optical waveguide 108B by the second reflection film 1064, and the beam width of the blue laser light transmitted from the second optical waveguide 108B is equal to the beam width of the red laser light.

The green laser light and the red laser light transmitted from the first optical waveguide 108a may be incident on the converging lens 103 through the second optical waveguide 108B, and the blue laser light and the red laser light transmitted from the second optical waveguide 108B may be directly incident on the converging lens 103.

In this way, by providing the two optical waveguides 108 in the projection device 1000, the beam widths of the red, green, and blue laser light can be equal, so that the color distribution of the light beams emitted from the light source 10 is uniform. In addition, the light beams can be directly converged by one converging lens 103 without arranging the second light combining mirror assembly 109 for combining the light beams, which is conducive to simplifying the internal structure of the projection device 1000 and achieving low-cost and lightweight design.

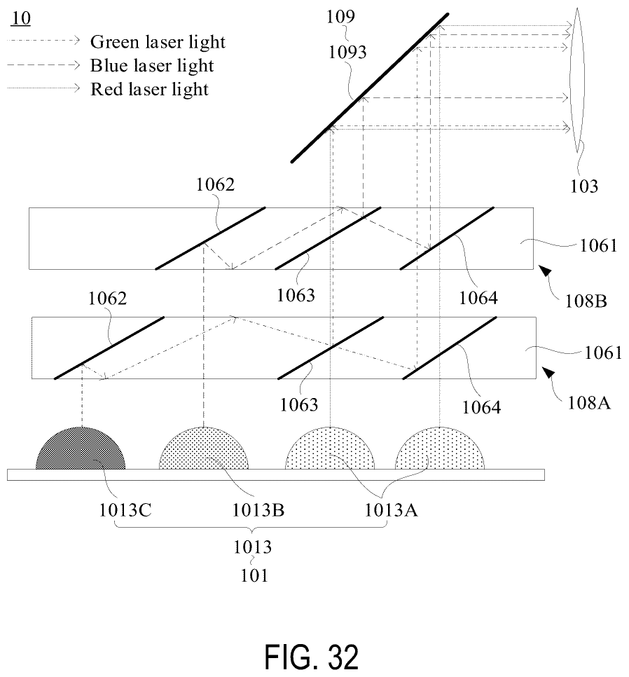

FIG. 32 is a light path diagram of a light source according to yet other embodiments. In other embodiments, the light source 10 in FIG. 31 may also include the second light combining mirror assembly 109. For example, as shown in FIG. 32, the light source 10 further includes the second light combining mirror assembly 109, the second light combining mirror assembly 109 includes a sixth light combining mirror 1093 configured to reflect the green laser light and the red laser light transmitted from the first optical waveguide 108A and the blue laser light and the red laser light transmitted from the second optical waveguide 108B in the same direction to achieve beam combination. For example, the sixth light combining mirror 1093 reflects the incident laser light of three colors toward the converging lens 103. By providing the sixth light combining mirror 1093, the laser light in the light source 10 can be turned to facilitate the display of the projection image, so that the projection device 1000 can be applied to more realistic scenes.

The structures and functions of the laser 101, the first optical waveguide 108A, and the second optical waveguide 108B can be referred to the relevant description in FIG. 31, and are not described herein again.

As described above, the light source 10 includes one laser 101, the laser 101 includes the plurality of first light emitting chips 1013A, the plurality of second light emitting chips 1013B, and the plurality of third light emitting chips 1013 C, and one or more optical waveguides 108 are located on the light outgoing side of the laser 101. In some embodiments, the light source 10 may alternatively include a plurality of lasers 101.

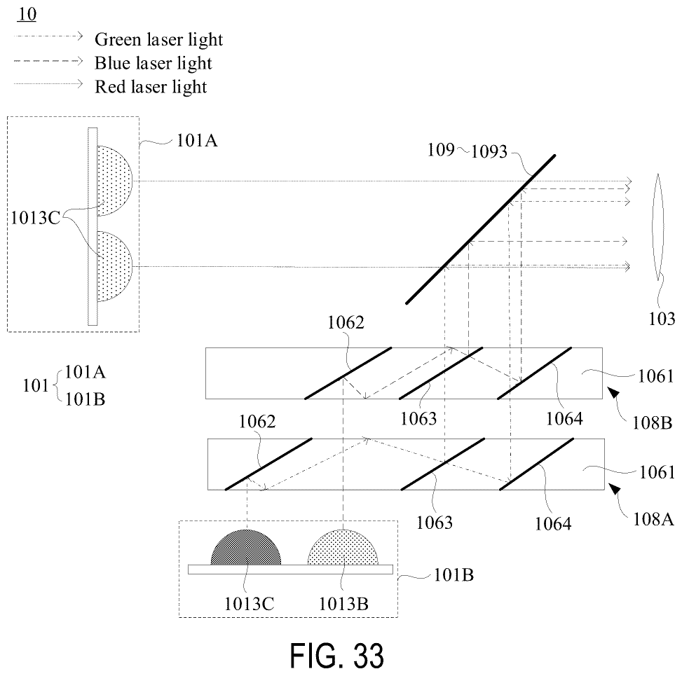

FIG. 33 is a light path diagram of a light source according to yet other embodiments. In some examples, as shown in FIG. 33, the plurality of lasers 101 includes a first laser 101A and a second laser 101B. The first laser 101A includes one or more first light emitting chips 1013A, and the second laser 101B includes one or more second light emitting chips 1013B and one or more third light emitting chips 1013C. The first optical waveguide 108A and the second optical waveguide 108B are located on a light outgoing side of the second laser 101B, and the second optical waveguide 108B is located on a side of the first optical waveguide 108A away from the second laser 101B. For example, as shown in FIG. 33, the first optical waveguide 108A is located on the light outgoing side of the plurality of third light emitting chips 1013C, and the second optical waveguide 108B is located on the light outgoing side of the plurality of second light emitting chips 1013B. The first optical waveguide 108A is configured to expand the beam width of the green laser light emitted from the plurality of third light emitting chips 1013C, and the second optical waveguide 108B is configured to expand the beam width of the blue laser light emitted from the plurality of second light emitting chips 1013B. In the first optical waveguide 108A, a distance between the first transflective film 1063 and the second reflection film 1064 is equal to the beam width of the red laser light emitted from the plurality of first light emitting chips 1013A in the first laser 101A. In the second optical waveguide 108B, a distance between the first transflective film 1063 and the second reflection film 1064 is equal to the beam width of the red laser light emitted from the plurality of first light emitting chips 1013A in the first laser 101A.

In this case, the light source 10 further includes a second light combining mirror assembly 109, the second light combining mirror assembly 109 includes a sixth light combining mirror 1093 configured to reflect the blue laser light and the green laser light and transmit the red laser light.

The red laser light emitted from the plurality of first light emitting chips 1013A in the first laser 101A is transmitted to the converging lens 103 through the sixth light combining mirror 1093. The green laser light emitted from the plurality of third light emitting chips 1013C in the second laser 101B is expanded to the same beam width as the red laser light through the first optical waveguide 108A, and the blue laser light emitted from the plurality of second light emitting chips 1013B in the second laser 101B is expanded to the same beam width as the red laser light through the second optical waveguide 108B. The green laser light and the blue laser light are respectively reflected by the sixth light combining mirror 1093 to the converging lens 103, and the converging lens 103 converges the red, green and blue laser light.

A configuration in which the light source 10 includes two lasers 101 may also be used in the laser 101 shown in FIG. 19. In this way, the configuration in which the light source 101 includes two lasers 101 can be applied to the case in which the lasers 101 include different numbers of light emitting chips of three colors. It should be noted that the two lasers 101 in FIG. 33 may also correspond to only one optical waveguide 108, and the structure and function of the optical waveguide 108 can be referred to the related description above, and are not described herein again.

In the description of the above embodiments, specific features, structures, materials, or characteristics may be combined in a suitable manner in any one or more embodiments or examples.

Those skilled in the art should understand that the foregoing descriptions are not intended to limit the protection scope of the present disclosure. Any variation or replacement readily figured out by a person skilled in the art within the technical scope disclosed in the present disclosure shall all fall within the protection scope of the present disclosure. The protection scope of the present disclosure shall be subject to the protection scope of the appended claims.

What is claimed is:

1. A projection device, comprising:
a light source configured to emit laser light of a plurality of colors as an illumination beam;
a light homogenizing member located on a light outgoing side of the light source and configured to homogenize the illumination beam incident thereon;
an optical modulating assembly configured to modulate the homogenized illumination beam to obtain a projection beam; and
a lens located on a light outgoing side of the optical modulating assembly and configured to project the projection beam to form a projection image;
wherein the light source comprises:
at least one laser configured to emit the laser light of the plurality of colors, and
a beam reshaping member comprising a plurality of beam reshaping regions, wherein the laser light of the plurality of colors is respectively incident on the plurality of beam reshaping regions, and the laser light of different colors is respectively incident on different beam reshaping regions, a size of each of a plurality of light spots formed by the laser light of the plurality of colors on the beam reshaping member in a first direction is greater than a size of the same light spot in a second direction, the first direction being perpendicular to the second direction, each of the beam reshaping regions comprises a plurality of diffraction microstructures, the diffraction microstructures in different beam reshaping regions are different, the beam reshaping member are configured to diffract the laser light of the plurality of colors through the plurality of diffraction microstructures in the plurality of beam reshaping regions respectively to form a plurality of rectangular spots and transmit the laser light of the plurality of colors toward a same region, so that a plurality of light spots formed by the laser light of the plurality of colors after passing through the beam reshaping member are combined, wherein a size and a shape of each rectangular spot match a size and a shape of a light spot required by the light homogenizing member.

2. The projection device according to claim 1, wherein the plurality of beam reshaping regions are configured to shrink corresponding laser light in the first direction and the second direction, and a shrinkage degree of the laser light in the first direction is greater than a shrinkage degree of the laser light in the second direction.

3. The projection device according to claim 1, wherein the plurality of beam reshaping regions are configured to expand corresponding laser light in the first direction and the second direction, and an expansion degree of the laser light in the first direction is less than an expansion degree of the laser light in the second direction.

4. The projection device according to claim 1, wherein the laser comprises a plurality of light emitting chips, each of the plurality of light emitting chips is configured to emit one sub-beam, so that the plurality of light emitting chips emit a plurality of sub-beams, and the laser light corresponding to each color comprises two or more sub-beams; and
the plurality of beam reshaping regions are configured to diffract received laser light to expand the plurality of sub-beams, so that the light spots formed by the plurality of sub-beams of the laser light of the plurality of colors after passing through the plurality of beam reshaping regions are combined.

5. The projection device according to claim 1, wherein an energy difference between any two positions of each of the light spots formed by the laser light of the plurality of colors after passing through the plurality of beam reshaping regions is less than an energy threshold.

6. The projection device according to claim 1, wherein the light spots formed by the laser light of the plurality of colors after passing through the plurality of beam reshaping regions are rectangular.

7. The projection device according to claim 1, wherein the at least one laser emits red laser light, green laser light, and blue laser light, the laser light of the three colors are respectively incident on three beam reshaping regions of the beam reshaping member, and each beam reshaping region is configured to diffract the laser light of the corresponding color incident thereon.

8. The projection device according to claim 1, wherein a light incident surface of the light homogenizing member is rectangular.

9. The projection device according to claim 8, wherein the light homogenizing member is a light guide provided with a rectangular light inlet.

10. The projection device according to claim 1, wherein the light homogenizing member comprises two fly-eye lenses opposite to each other, and the fly-eye lens is formed by a plurality of microlenses in an array, along an incident direction of the illumination beam, a focal point of the microlens in a first fly-eye lens coincides with a center of the corresponding microlens in a second fly-eye lens, and optical axes of the microlenses in the two fly-eye lenses are parallel to each other.

11. The projection device according to claim 1, wherein a ratio of a size of the light spot incident on the light homogenizing member in the first direction to a size of of the same spot in the second direction is 16:9 or 1:1.

12. The projection device according to claim 1, wherein the light homogenizing member is provided in the at least one light source.

13. The projection device according to claim 1, wherein the beam reshaping member comprises a diffractive optical element.

14. The projection device according to claim 13, wherein the diffractive optical element is a two-dimensional diffractive device capable of adjusting the laser light incident thereon directly in two directions.

15. The projection device according to claim 13, wherein the diffractive optical element comprises the plurality of diffraction microstructures distributed in two dimensions, each diffraction microstructure is rectangular, sizes and depths of the plurality of diffraction microstructures are different, and distances between different diffraction microstructures are different.

16. The projection device according to claim 1, wherein the beam reshaping member comprises a grating waveguide, and the grating waveguide comprises:
an optical waveguide configured to transmit laser light from a coupling-in grating to a coupling-out grating;
the coupling-in grating provided on the optical waveguide and configured to diffract received laser light in the first direction and transmit the received laser light to the optical waveguide; and
the coupling-out grating provided on the optical waveguide and configured to diffract received laser light in the second direction and transmit diffracted laser light out of the grating waveguide;
wherein each beam reshaping region comprises a first region in the coupling-in grating and a second region in the coupling-out grating, the first region is an irradiation region of the laser light of each color in the coupling-in grating, and the second region is an irradiation region of the laser light of each color in the coupling-out grating.

17. The projection device according to claim 16, wherein the diffraction microstructure is strip-shaped, and a length direction of the diffraction microstructure in the coupling-in grating is perpendicular to a length direction of the diffraction microstructure in the coupling-out grating.

18. The projection device according to claim 1, wherein the optical modulating assembly comprises:
the light homogenizing member;
a volume grating located on a light outgoing side of the light homogenizing member and configured to diffract the illumination beam from the light homogenizing member, wherein a thickness, a period, and a refractive index variation of the volume grating is configured such that a spot size and an outgoing angle of the laser light diffracted by the volume grating satisfy an incident condition of an optical modulating member, a predetermined angle is formed between a light outgoing surface of the volume grating and a light incident surface of the optical modulating member, and the predetermined angle satisfies an incident angle condition of the laser light incident on the optical modulating member; and
the optical modulating member located on a light outgoing side of the volume grating and configured to modulate the illumination beam transmitted from the volume grating to obtain the projection beam.

19. The projection device according to claim 18, wherein the optical modulating member is a digital micromirror device, and a light incident surface of the digital micromirror device is rectangular.

20. A projection system comprising:
the projection device according to claim 1; and
a projection screen located on a light outgoing side of the projection device.
